(19) United States
(12) Patent Application Publication
(10) Pub. No.: US 2016/0321744 A1
(43) Pub. Date: Nov. 3, 2016

(54) SYSTEMS AND METHODS FOR AUTOMATED MANAGEMENT OF CONTRACTS BETWEEN FINANCIAL INSTITUTIONS AND VENDORS, AUTOMATED PREPARATION OF EXAMINATION REPORTS, AND AUTOMATED MANAGEMENT OF EXAMINATION REPORTS

(71) Applicant: Venminder, Inc., Elizabethtown, KY (US)

(72) Inventor: Dana Bowers, Elizabethtown, KY (US)

(21) Appl. No.: 15/086,954

(22) Filed: Mar. 31, 2016

Related U.S. Application Data
(60) Provisional application No. 62/140,551, filed on Mar. 31, 2015.

(51) Int. Cl. G06Q 40/02; G06Q 30/00

(52) U.S. Cl. CPC G06Q 40/02; G06Q 30/018

(57) ABSTRACT

Methods and systems are presented herein for managing contracts between a financial institution and its vendors, for preparation of associated vendor oversight reports, and for securing subscriptions for a financial institution/vendor relationship management system. In certain embodiments, the system provides a guided workflow-driven process for building a complete report for auditors and examiners. In certain embodiments, the system encourages subscriptions from financial institutions for a financial institution/vendor relationship management system.

### RELATED APPLICATIONS

This application claims the benefit of and priority to U.S. Provisional Patent Application No. 62/140,551, filed on Mar. 31, 2015 and titled “Systems and Methods for Automated Management of Contracts Between Financial Institutions and Vendors, Automated Preparation of Examination Reports, and Automated Management of Examination Reports,” the contents of which are incorporated herein by reference in their entirety. This application is related to U.S. Provisional Patent Application No. 61/805,066, filed Mar. 25, 2013, titled “Systems and Methods for Managing Contracts Between a Financial Institution and Its Vendors,” and to U.S. Non-Provisional patent application Ser. No. 14/225,217, filed Mar. 25, 2014 and titled “Systems and Methods for Managing Contracts Between a Financial Institution and Its Vendors,” the contents of which are incorporated herein by reference in their entirety.

### FIELD OF THE INVENTION

This invention relates generally to systems and methods for managing client/vendor relationships. More particularly, in certain embodiments, the invention relates to systems and methods for managing contracts between a financial institution and its vendors and for preparation of associated vendor oversight reports, and to managing examination reports.

### BACKGROUND

Financial institutions such as banks and credit unions are increasingly relying on third-party vendors to perform various important functions. While this improves efficiency and reduces cost for the financial institution, there are various risks posed by such outsourcing. A financial institution must establish a vendor oversight program to mitigate such risks, comply with various regulations, and pass examination by auditors.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Examination reports regarding vendor products have traditionally been provided to examiners in paper form, or using non-centralized digital means (e.g., e-mail). That is, members of a financial institution have traditionally delivered, by mail, email, or the like, examination reports on a one-on-one basis. Examiners have traditionally accessed examination reports one by one, as they are received from each member.

There is a need for a consolidated, efficient system for managing contracts between a financial institution and its vendors and for preparation of associated vendor oversight reports. There is also a need, therefore, for a centralized system for generating, managing, and distributing examination reports, whereby a plurality of examiners are centrally and automatically given access to shared examination reports of or corresponding to a plurality of members.

### SUMMARY

Methods and systems are presented herein for managing contracts between a financial institution and its vendors, for preparation of associated vendor oversight reports, and for securing subscriptions for a financial institution/vendor relationship management system.

In one aspect, the invention is directed to a computer-implemented method for managing contracts between a financial institution and its vendors, the method comprising the steps of: (a) providing, by a processor of a computing device, a first graphical user interface (e.g., main dashboard or vendor dashboard) configured to display, for a given financial institution, a listing of vendor products and, upon selection of a listed vendor product by a user, to display details regarding the selected vendor product; (b) providing, by the processor, a second graphical user interface (e.g., upload widget) configured to facilitate uploading, by the user, of one or more contracts (and/or other documents) associated with the selected vendor product (e.g., for archival in the cloud, or other decentralized or centralized storage/archival server); (c) providing, by the processor, a third graphical user interface (e.g., guided exam prep workflow, series of widgets) configured to guide a user in preparation of a vendor oversight report associated with the selected vendor product (e.g., or associated with multiple products from a selected vendor); and (d) displaying, by the processor, a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

In some embodiments, the method comprises determining, by the processor, whether one or more uploaded contracts associated with the selected vendor product has an upcoming critical date (e.g., renewal date), activating an alert if a threshold in relation to the critical date and current date is met (e.g., critical date is 6 months away, 3 months away, etc.), and displaying an alert widget corresponding to the activated alert.

In some embodiments, the method comprises providing, by the processor, a graphical user interface configured to display one or more prompts for user entry of one or more of the following items corresponding to a selected vendor product or an associated uploaded contract: a contract renewal deadline, a vendor benchmark, a risk rating, a performance rating, a performance comment, a status (e.g., In-Term, Renewal Negotiation, Auto-Renew, Cancelled, or Replace), and contact information (e.g., name, email address, phone number) of a collaborator. In some embodiments, the one or more items prompted for user entry comprises a performance rating and a performance comment associated with the selected vendor product, wherein the entered performance rating is received anonymously (e.g., without association with the user entering the rating) and is compiled in a set of performance ratings received for the given vendor product by a plurality of users, wherein the method comprises displaying a composite performance rating and/or a listing of one or more performance comments received from users of the given vendor product (e.g., wherein the plurality of users represent a plurality of financial institutions). In some embodiments, the method comprises displaying, by the processor, the composite performance rating and/or the listing of one or more performance comments received from users of the given vendor product and/or one or more corresponding products provided by one or more different vendors. In some embodiments, the method comprises displaying, by the processor, one or more of the following corresponding to a given performance comment: a “like” prompt, a “dislike” prompt, a flag to identify inappropriate content. In some embodiments, the method comprises displaying a listing of a plurality of performance comments received from users of the given vendor product, wherein the listing is ordered on the graphical user interface according to popularity (e.g., number of “likes” received for each of the performance comments).

In some embodiments, the method comprises providing a graphical communication portal (e.g., a ‘private message’ window) allowing a user to anonymously solicit a textual message regarding a given vendor product by the vendor and/or to anonymously solicit a textual message regarding a given performance rating or performance comment by the user who provided the given performance rating or performance comment.

In some embodiments, the method comprises storing the one or more contracts and/or other documents associated with the selected vendor product (e.g., in the cloud, or other decentralized or centralized storage/archival server), and displaying icons and/or text corresponding to a set of folders for organizing the documents associated with the selected vendor product. In some embodiments, the set of folders for organizing the documents associated with the selected vendor product comprises a compliance document folder with text indicating it contains compliance documents. In some embodiments, selection by the user of the compliance document folder results in presentation, by the processor, of a set of subfolders, wherein the set of subfolders comprises text indicating one or more of the following categories: Audit/IT, Business Continuity, Financial, Insurance, Miscellaneous, Policy, and Product Management.

In some embodiments, the one or more items prompted for user entry comprises contact information (e.g., name, email address, phone number) of one or more collaborators for the selected vendor product. In some embodiments, the method comprises restricting access to stored documents and/or other information (e.g., reminders, notes, emails, etc.) regarding the selected vendor product, and/or restricting ability to upload documents and/or other information (e.g., reminders, notes, emails, etc.) pertaining to the selected vendor product, to a group of collaborators at a given financial institution named for that vendor product.

In some embodiments, step (c) comprises providing, by the processor, a guided workflow configured to guide a user in preparation of a vendor oversight report associated with the selected vendor product, wherein the guided workflow comprises a series of widgets (e.g., where a widget is a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and/or a scroll bar) prompting entry (e.g., sequential entry) or upload of one or more of the following: (i) the risk level associated with the selected vendor product; (ii) a date of next regulatory exam (e.g., wherein the method provides, by the processor, one or more reminder notification emails to the user based on the date of next regulatory exam); (iii) a selection of agency(ies) that apply to the financial institution user (e.g., CFPBC, FDIC, FED, NCUA, OCC, e.g., wherein the method provides, by the processor, a format for and/or fillable content for the vendor oversight report based on the selected agency(ies)); (iv) documents for use in preparation of the vendor oversight report (e.g., wherein the method displays, by the processor, a listing of previously uploaded documents associated with the selected vendor product alongside a listing of suggested document types for inclusion in the vendor oversight report, said suggested document types identified based on the risk level associated with the selected vendor product, e.g., wherein the method provides a widget that facilitates, by the processor, a drag-and-drop by the user of items from the listing of uploaded documents onto a corresponding suggested document type to identify said uploaded document as a document of said type, for inclusion of the linked uploaded document in the vendor oversight report); (v) textual commentary regarding the selected vendor product and/or the vendor of the selected vendor product; and (vi) a request for assistance (e.g., assistance by a collaborator associated with the selected vendor product or by another worker at the financial institution of the user). In some embodiments, the guided workflow displays a current status of the vendor oversight report associated with the selected vendor product (e.g., Not Started, Waiting on expert, Waiting for documents, Skipped, In Progress, or Complete). In some embodiments, the guided workflow displays a visual checklist of documents the financial institution has received from the vendor regarding the selected vendor product, and documents remaining to be obtained from the vendor prior to completion of the vendor oversight report associated with the selected vendor product.

In some embodiments, the method is a computer-implemented method for managing contracts between a financial institution and its vendors and for preparation of associated vendor oversight reports as part of a financial institution/vendor relationship management system.

In some implementations, the method may include providing, by the processor, a graphical user interface configured to display one or more prompts for a user entry associated with a risk assessment of a given vendor product (e.g., wherein the given vendor product is related to at least one of Information Access, Operational and Financial Dependency, and Regulatory Exposure). The user entry may be in response to a set of questionnaires.

In some implementations, the graphical user interface may provide a dashboard that displays all of the existing risk-assessment evaluation and the completed risk-assessment evaluation performed by a given organization associated to an end-user. The graphical user interface may display a first list of vendor products having never had a risk assessment completed, a second list of vendor products having an annual risk assessment due, and a third list of vendor products that are currently being assessed or have been completed within the last year.

In some implementations, the method may include determining, by the processor, whether a request to initiate risk assessment for the given vendor product is a duplicate of an existing risk-assessment evaluation or a completed risk-assessment evaluation. The method may include preventing, by the processor, the request from initiating a new risk-assessment evaluation for the same product.

In another aspect, the invention is directed to a financial institution/vendor relationship management system for managing contracts between a financial institution and its vendors and for preparation of associated vendor oversight reports, the system comprising: a data management module configured to store data (e.g., documents and/or information) pertaining to a set of vendor products for a financial institution, said data accessible by a computing device (e.g., a portable computing device), the computing device comprising: a processor; and a non-transitory computer readable medium storing instructions thereon, wherein the instructions, when executed, cause the processor to: (a) provide a first graphical user interface (e.g., main dashboard or vendor dashboard) to display on the computing device, for a given financial institution, a listing of vendor products and, upon selection of a listed vendor product by a user via the computing device, to display details regarding the selected vendor product; (b) provide a second graphical user interface (e.g., an upload widget) on the computing device to facilitate uploading, by the user, of one or more contracts (and/or other documents) associated with the selected vendor product via the computing device (e.g., for archival in the cloud, or other decentralized or centralized storage/archival server); (c) provide a third graphical user interface (e.g., guided exam prep workflow, series of widgets) on the computing device to guide a user in preparation of a vendor oversight report associated with the selected vendor product (e.g., or associated with multiple products from a selected vendor); and (d) display on the computing device a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

In another aspect, the invention is directed to a method for securing subscriptions for a financial institution/vendor relationship management system for managing contracts between a financial institution and its vendors and for preparation of associated vendor oversight reports, the method comprising the steps of: (a) providing, by a processor of a computing device, a web-based graphical user interface that facilitates uploading by a vendor of compliance documentation; (b) displaying, by the processor, one or more widgets (e.g., where a widget is a window, a text box, a button, a hyperlink, a drop-down list, a list box, a combo box, a check box, a radio button, a cycle button, a data-grid, a spinner, a menu, a menu bar, a toolbar, an icon, a tree view, a grid view, a link, a tab, and/or a scroll bar) prompting secure upload (e.g., to the cloud, or other decentralized or centralized storage/archival server) of compliance documents associated with a given vendor product owned by a financial institution identified by the vendor and/or prompting entry, by the vendor, of one or more of: (i) compliance data, and (ii) financial institution contact information (e.g., email address) associated with the given vendor product; and (c) sending, by the processor, an email notification to the financial institution identified by the vendor that compliance data and/or compliance documents have been uploaded by the vendor, wherein the email notification comprises an invitation to the financial institution to enter into a subscription to retrieve the uploaded data and/or documents via the relationship management system. In some embodiments, the method comprises displaying, by the processor, an invitation to a user at the financial institution an offer to upgrade the subscription (e.g., where an initial subscription is free, and an upgrade is available to manage more than one vendor product and/or to expand available storage space for archival of uploaded data and/or documents corresponding to a vendor product. In some embodiments, the subscription includes use of the financial institution/vendor relationship management system.

In some example embodiments, a system is provided for managing examination reports and contracts between and among members of a network comprising financial institutions, financial institution vendors, and examiners, the system comprising: a memory, and a processor communicatively coupled to the memory, the processor being operable to: provide a network including user computing devices corresponding to users and to examiner systems corresponding to examiners, wherein each of the users is one or more of a general user, administrator, vendor manager, product manager, expert, and executive; store, in the memory, at least one of a plurality of user records corresponding to the users on the network, a plurality of examiner records corresponding to the examiners on the network, and a plurality of examination report records; receive, from a user computing device corresponding to a user, over the network, a request to share an examination report record from the plurality of examination report records, the request including at least one of an examination report date, vendor, product and examiner information; and update access settings associated with the examination report record identified in the request, the access setting being updated to indicate that the examination report record is accessible by an examiner corresponding to the examiner information included in the request.

In some example embodiments, the processor is operable to: cause to display a first graphical user interface including a list of examination report records selected from the plurality of examination records stored in the memory, wherein for each examination report record, the first graphical user interface includes one or more of a report date, vendor name, product name, risk rating and user name associated with the examination report record.

In some example embodiments, for each examination report record, the first graphical user interface includes one or more of a comment option and an e-mail option to transmit information to users associated with examination report records.

In some example embodiments, the first graphical user interface includes an indication (e.g., badge, icon) identifying examination report records newly added to the list of examination report records.

In some example embodiments, the first graphical user interface is caused to be displayed at an examiner system corresponding to an examiner associated with the list of examination report records.

In some example embodiments, the examination report records stored in the memory include corresponding access settings, the access setting including one or more examiners with which to share the respective examination report record.

In some example embodiments, the processor is further operable to: receive, via an input in the first graphical user interface, an access request to access an examination report record from the list of examination report records; and cause to display, in response to the access request, at least a portion of the examination report record identified in the access request.

In some example embodiments, the access request is received from an examiner system over the network, the examiner system corresponding to an examiner associated with the examination report record, and wherein the portion of the examination report record is caused to be displayed at the examiner system.

In some example embodiments, the processor is operable to: cause to display a second graphical user interface including a list of users and a list of examiners, the graphical user interface including one or more of a button to add a user, a button to add an examiner, a link to edit a user for each of the plurality of users, and a link to edit an examiner for each of the plurality of examiners, wherein selection of the button to add a user causes a third graphical user interface to be displayed, selection of the button to add an examiner causes a fourth graphical user interface to be displayed, selection of a link to edit a user causes a fifth graphical user interface to be displayed, and selection of a link to edit an examiner causes a sixth graphical user interface to be displayed

In some example embodiments, the third graphical user interface includes user information corresponding to the user of the plurality of users, wherein the processor is operable to: receive updated user information; and update the user record corresponding to the user, based on the received updated user information.

In some example embodiments, the fourth graphical user interface includes examiner information corresponding to the examiner of the plurality of examiners, the processor is further operable to: receive updated examiner information; and update the examiner record corresponding to the examiner, based on the received updated examiner information.

In some example embodiments, at least a portion of the plurality of examination report records are received, over the network, from entities administering examinations identified in the examination report records.

In some example embodiments, a method is provided for managing examination reports, comprising: providing a network including user computing devices corresponding to users and to examiner systems corresponding to examiners, wherein each of the users is one or more of a general user, administrator, vendor manager, product manager, expert, and executive; storing, in a memory, at least one of a plurality of user records corresponding to the users on the network, a plurality of examiner records corresponding to the examiners on the network, and a plurality of examination report records; receiving, from a user computing device corresponding to a user, over the network, a request to share an examination report record from the plurality of examination report records, the request including at least one of an examination report date, vendor, product and examiner information; and updating access settings associated with the examination report record identified in the request, the access setting being updated to indicate that the examination report record is accessible by an examiner corresponding to the examiner information included in the request.

In some example embodiments, the method further comprises: causing to display a first graphical user interface including a list of examination report records selected from the plurality of examination records stored in the memory, wherein for each examination report record, the first graphical user interface includes one or more of a report date, vendor name, product name, risk rating and user name associated with the examination report record.

In some example embodiments, for each examination report record, the first graphical user interface includes one or more of a comment option and an e-mail option to transmit information to users associated with examination report records.

In some example embodiments, the first graphical user interface includes an indication (e.g., badge, icon) identifying examination report records newly added to the list of examination report records.

In some example embodiments, the first graphical user interface is caused to be displayed at an examiner system corresponding to an examiner associated with the list of examination report records.

In some example embodiments, each of the examination report records stored in the memory include corresponding access settings, the access setting including one or more examiners with which to share the respective examination report record.

In some example embodiments, the method further comprises: receiving, via an input in the first graphical user interface, an access request to access an examination report record from the list of examination report records; and causing to display, in response to the access request, at least a portion of the examination report record identified in the access request.

In some example embodiments, the access request is received from an examiner system over the network, the examiner system corresponding to an examiner associated with the examination report record, and wherein the portion of the examination report record is caused to be displayed at the examiner system.

In some example embodiments, the method further comprises causing to display a second graphical user interface including a list of users and a list of examiners, the graphical user interface including one or more of a button to add a user, a button to add an examiner, a link to edit a user for each of the plurality of users, and a link to edit an examiner for each of the plurality of examiners, wherein selection of the button to add a user causes a third graphical user interface to be displayed, selection of the button to add an examiner causes a fourth graphical user interface to be displayed, selection of a link to edit a user causes a fifth graphical user interface to be displayed, and selection of a link to edit an examiner causes a sixth graphical user interface to be displayed.

In some example embodiments, the third graphical user interface includes user information corresponding to the user of the plurality of users, wherein the method further comprises: receiving updated user information; and updating the user record corresponding to the user, based on the received updated user information.

In some example embodiments, the fourth graphical user interface includes examiner information corresponding to the examiner of the plurality of examiners, wherein method further comprises: receiving updated examiner information; and updating the examiner record corresponding to the examiner, based on the received updated examiner information.

In some example embodiments, at least a portion of the plurality of examination report records are received, over the network, from entities administering examinations identified in the examination report records.

The description of elements of the embodiments with respect to one aspect of the invention can be applied to another aspect of the invention as well. For example, features described in a claim depending from an independent method claim may be applied, in another embodiment, to an independent system claim.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors according to an exemplary embodiment.

FIG. 2 is a block diagram of an example system for managing contracts between the financial institution and its vendors in accordance with an example embodiment.

FIG. 3A is an example main dashboard in accordance with an example embodiment.

FIG. 3B is an example of an expanded version of a vendor product list.

FIG. 3C is an example of an interface displaying a list, table or the like of contracts.

FIG. 4 is an example vendor dashboard in accordance with an example embodiment.

FIG. 5 is an example document storage page in accordance with an example embodiment.

FIG. 6 is an example workflow of a system for guiding an end-user in preparing a vendor oversight report associated with one or more selected vendor products in accordance with an example embodiment.

FIG. 7 is an example vendor exam preparation workspace in accordance with an example embodiment.

FIG. 8 is an example workspace for collecting documents by matching a collected end-user's document to a list of suggested documents in accordance with an example embodiment.

FIG. 9 is an example workspace for collecting documents by prompting the end user to select actions for unassigned documents that have been provided by the end user in accordance with an example embodiment.

FIG. 10 is an example workspace for collecting documents by prompting the end user to select actions for unassigned suggested documents in accordance with an example embodiment.

FIG. 11 is an example workspace for preparing a collected document for the examination report in accordance with an example embodiment.

FIG. 12 is an example workspace for uploading documents to be attached and included in the examination in accordance with an example embodiment.

FIG. 13 is an example workspace to preview contents to be included in the examination report.

FIG. 14 is an example workspace to review vendor products in accordance with an example embodiment.

FIG. 15 is an example display for viewing product reviews in accordance with an example embodiment.

FIG. 16 is an example alert and information display in accordance with an example embodiment.

FIG. 17 is an example workspace for performing a risk-assessment evaluation of a vendor product in accordance with an example embodiment.

FIG. 18 is an example workspace to initiate a new risk assessment of a vendor product in accordance with an example embodiment.

FIG. 19 is an example workspace to view risk assessments that are in-progress in accordance with an example embodiment.

FIG. 20 is an example workspace to view completed risk-assessment evaluations in accordance with an example embodiment.

FIG. 21 is an example dashboard to manage risk-assessment evaluation of vendors and vendor products in accordance with an example embodiment.

FIG. 22 is an example risk-assessment workspace in accordance with an example embodiment.

FIG. 23 is an example invitation-workspace to invite peers to contribute to a risk-assessment evaluation in accordance with an example embodiment.

FIG. 24 is an example request-message for peer collaborative input for a given risk-assessment evaluation in accordance with an example embodiment.

FIG. 25 is a diagram of a system for managing examination reports in accordance with an exemplary embodiment.

FIG. 26A illustrates a graphical user interface for managing examination reports in accordance with an exemplary embodiment.

FIG. 26B illustrates a graphical user interface for accessing information regarding the sharing of examination reports with examiners in accordance with an exemplary embodiment.

FIG. 27A illustrates a graphical user interface for managing examination reports in accordance with an exemplary embodiment.

FIG. 27B illustrates a graphical user interface for confirming the sharing of an examination report in accordance with an exemplary embodiment.

FIG. 27C illustrates a graphical user interface for sharing an examination report with an examiner in accordance with an exemplary embodiment.

FIG. 27D illustrates a graphical user interface for confirming sharing of an examination report, in accordance with an exemplary embodiment.

FIG. 28A illustrates a graphical user interface for managing users and examiners in accordance with an exemplary embodiment.

FIG. 28B illustrates a graphical user interface for editing records associated with an examiner in accordance with an exemplary embodiment.

FIG. 28C illustrates a graphical user interface for adding records associated with new examiners being entered into the system, in accordance with an exemplary embodiment.

FIG. 29 illustrates a graphical user interface for editing user information in accordance with an exemplary embodiment.

FIG. 30 illustrates a graphical user interface for enrolling examiners in a record management system in accordance with an exemplary embodiment.

FIG. 31A includes a graphical user interface for viewing reports in accordance with an exemplary embodiment.

FIG. 31B illustrates a graphical user interface for protecting files, according to an exemplary embodiment.

FIG. 32A illustrates a graphical user interface for uploading a contract, according to an exemplary embodiment.

FIG. 32B illustrates a graphical user interface for selecting a vendor associated with a contract to upload, according to an exemplary embodiment.

FIG. 32C illustrates a graphical user interface for selecting a product associated with the contract to be uploaded, according to an exemplary embodiment.

FIG. 32D illustrates a graphical user interface for adding a new vendor product, according to an exemplary embodiment.

FIG. 33A illustrates a graphical user interface for viewing and uploading contracts, according to an exemplary embodiment.

FIG. 33B illustrates a graphical user interface for viewing and uploading contracts, according to an exemplary embodiment.

FIG. 33C illustrates a vendor dashboard for viewing and uploading contracts, according to an exemplary embodiment.

FIG. 34A illustrates a graphical user interface for viewing contract details, according to an exemplary embodiment.

FIG. 34B illustrates a graphical user interface for adding an addendum to a contract, according to an exemplary embodiment.

FIG. 34C illustrates a graphical user interface for editing data associated with a contract, according to an exemplary embodiment.

FIG. 34D illustrates a graphical user interface for editing data associated with a contract, according to an exemplary embodiment.

FIG. 34E illustrates a graphical user interface for adding a custom data field to contract details, according to an exemplary embodiment.

FIG. 34F illustrates a graphical user interface for adding a custom field and custom data to a contract and its details, according to an exemplary embodiment.

FIG. 34G illustrates a graphical user interface for displaying contract details, according to an exemplary embodiment.

FIG. 35A illustrates a graphical user interface for adding addendums, according to an exemplary embodiment.

FIG. 35B illustrates a graphical user interface for adding addendums, according to an exemplary embodiment.

FIG. 35C illustrates a graphical user interface for confirming addition of an addendum, according to an exemplary embodiment.

FIG. 35D illustrates a graphical user interface for adding products, according to an exemplary embodiment.

FIG. 36A illustrates a graphical user interface for processing contracts according to an exemplary embodiment.

FIG. 36B illustrates a graphical user interface for processing a contract, according to an exemplary embodiment.

FIG. 37A illustrates a graphical user interface for modifying a contract status, according to an exemplary embodiment.

FIG. 37B illustrates a graphical user interface, in which a selection has been made to move a contract from a cancelled status to an in-term status, according to an exemplary embodiment.

FIG. 38A illustrates a graphical user interface for cancelling a contract, according to an exemplary embodiment.

FIG. 38B illustrates a graphical user interface for displaying contract details, according to an exemplary embodiment.

FIG. 39A illustrates a graphical user interface for displaying notifications related to a contract, according to an exemplary embodiment.

FIG. 39B illustrates a calendar widget for viewing reminders, according to an exemplary embodiment.

FIG. 39C illustrates a graphical user interface for displaying reminder information, according to an exemplary embodiment.

FIG. 39D illustrates a graphical user interface for displaying a list of contract renewals, according to an exemplary embodiment.

FIG. 40 is a block diagram of an example network environment for use in the methods and systems described herein, according to an example embodiment.

FIG. 41 is a block diagram of an example computing device and an example mobile computing device, for use in example embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Methods and systems are presented herein for managing contracts between a financial institution and its vendors, for preparation of associated vendor oversight reports, securing subscriptions for a financial institution/vendor relationship management system and managing examination reports.

In certain embodiments, a web-based system is provided for improved vendor contract management, enhanced collaboration within a financial institution, and organized, step-by-step vendor oversight report preparation. For example, the contract management feature allows financial institutions to store contracts, enter key terms and other information in order to set reminders and benchmark against like vendors. The collaboration feature allows multiple users of a given financial institution to store documentation, set reminders, make notes, upload emails, and the like, for purposes of managing various aspects of a vendor relationship, including day-to-day service management, accounts payable, and risk management. The vendor rate-and-review feature allows financial institutions to rate and review individual vendor products and see the ratings and reviews that other financial institutions have provided. In certain embodiments, a star rating system is employed, and open comments may be provided by name or anonymously. Inappropriate comments may be flagged, and listings of reviews may be ranked by popularity.

In certain embodiments, the examination preparation feature provides a guided workflow-driven process for building a complete report for auditors and examiners. It provides a process for matching risk ratings to suggested risk management content that a financial institution should review annually for at least their high-to-moderate risk vendors. Then, vendor documentation is matched to suggested content, creating a visual checklist of what the financial institution has received from the vendor and what they are missing and may still need to collect. This allows for general, more strategic level comments at the vendor and product level, and supports specific review of each document provided by the vendor. A financial institution user may invite an expert (e.g., from within the same financial institution) for help with complex document reviews such as IT audits or financials. Output is a compiled report of financial institution comments, supporting documentation, and vendor documents.

Embodiments of the system architecturally bridge relationships between financial institutions and their vendors so that there is only ever a single instance of a given financial institution or vendor in the system. This allows aggregation of information for vendors providing similar products, financial institutions with similar characteristics, and provides for other synergies. There is a high degree of user-friendliness, because backbone data can be shared (e.g., primary financial institution and vendor records), without compromising private data that an individual financial institution or vendor enters that should not be exposed to others.

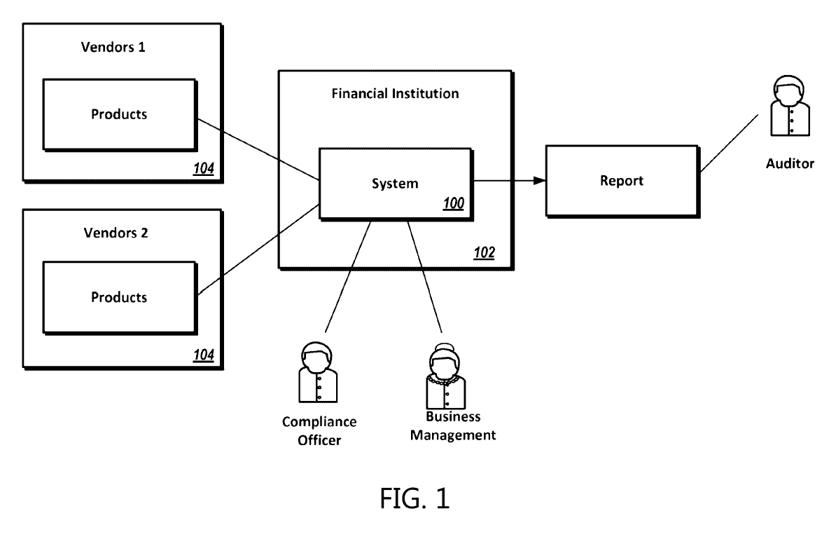

FIG. 1 is a block diagram of an example system 100 to assist financial institutions 102 in managing vendors 104 in accordance with an example embodiment. In some implementations, the system 100 provides guided workflow i) to manage contracts with a given vendor 104, to provide a guided workflow to assist the financial institution 102 to prepare for an compliance or contract audit examination, ii) to provide a rating system of the vendors 104 and their products and services, iii) to provide a risk-assessment rating-system for the vendors 104, and iv) to provide mechanisms for collaboration, tracking of communication, and document storage.

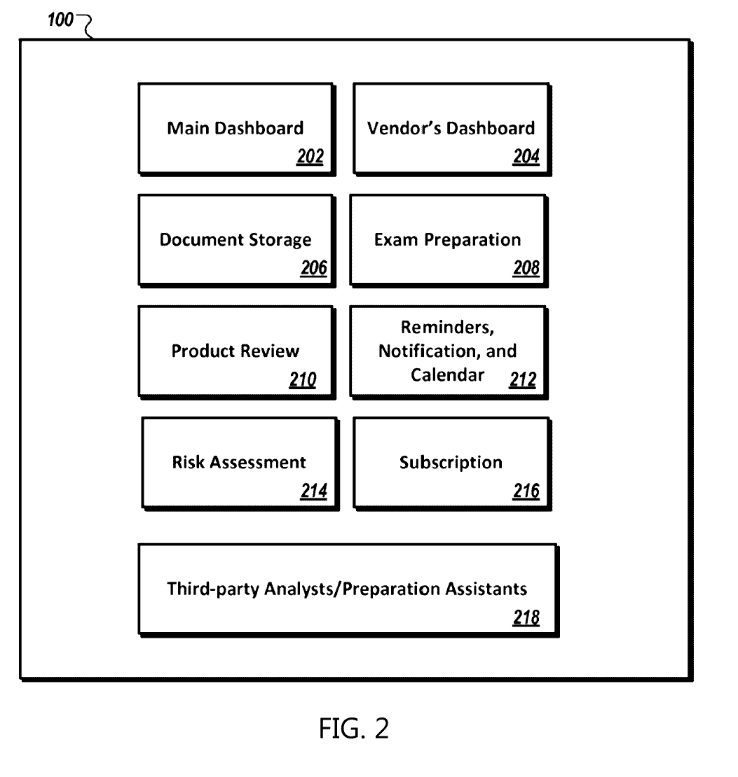

FIG. 2 is a block diagram of the example system 100 for managing contracts between the financial institution and its vendors in accordance with an example embodiment. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some example embodiments, the document storage page 206 is accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and the like.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various systems' components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

Main Dashboard

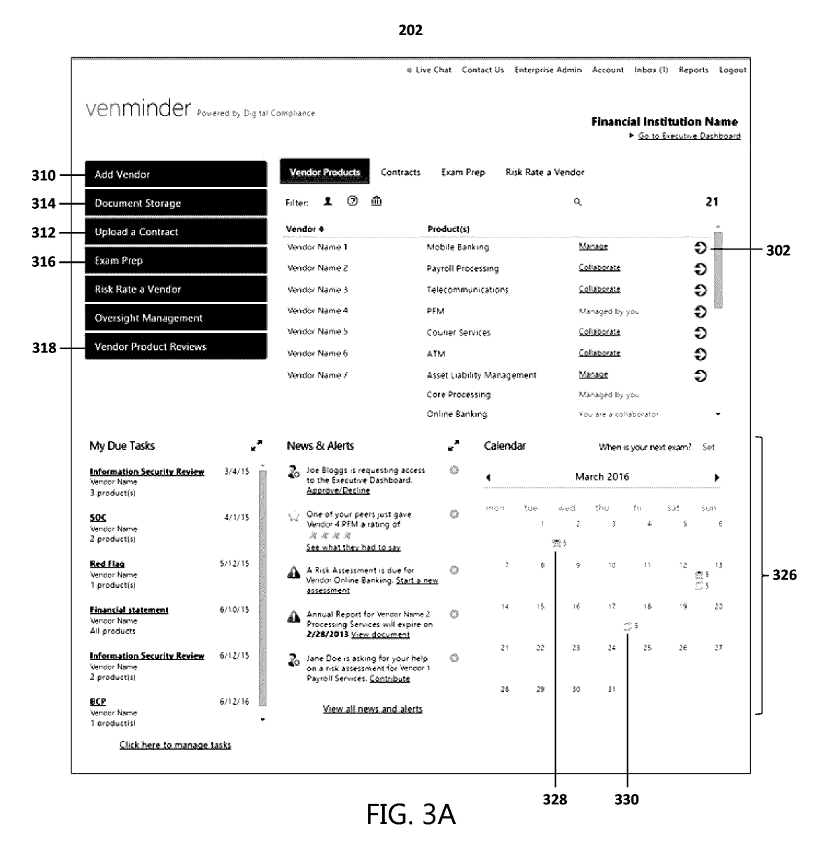

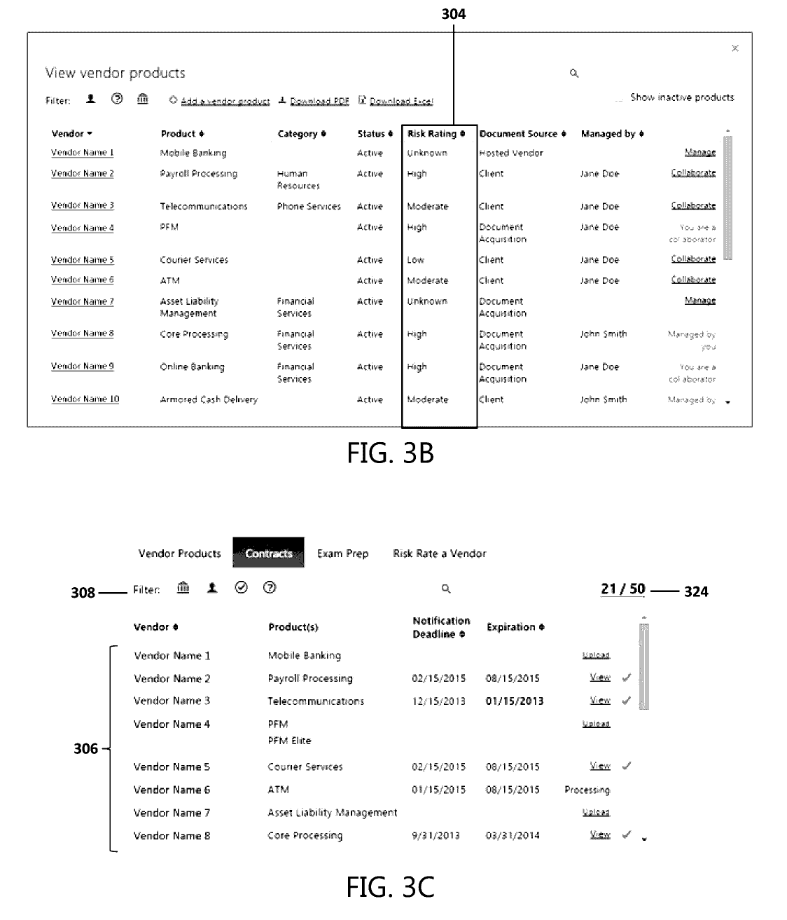

FIG. 3A is an example main dashboard 202 in accordance with an exemplary embodiment. The main dashboard 202 may be used to initiate various functions described in relation to FIG. 2. The main dashboard 202 may display a vendor product list (or table, or the like) 302, which may be organized and filtered by a vendor's risk level 304 (e.g., low, moderate, high, or unknown). FIG. 3B illustrates an expanded version of the vendor product list 302, which may be accessed, for example, by clicking the “Vendor Products” caption or the product list 302 itself, which may cause the list (or table) to be expanded. As shown in FIG. 3B, the view vendor products screen includes a list of vendor products corresponding to rows on a table. Each column represents a field or parameter associated with each vendor product, including: vendor, product, category, status, risk rating, document source, managed by (e.g., name, identifier) and available actions. For example, the vendor products may be sorted or organized on the table according to risk rating, by clicking on the header of the “Risk Rating” column 304. In some example embodiments, the vendor product list may also be sorted, organized and filtered by, for example, product ownership and contract availability (e.g., by clicking on a corresponding column header).

With reference to FIG. 3A, the main dashboard 202 may include a calendar 326 that displays reminder dates 328 and expiration dates 330 of contracts, risk assessment of vendors and/or products, as well as of upcoming examinations. In some example embodiments, the calendar 326 may include dates in which notifications will be sent by the system. In some example embodiments, the calendar 326 may display the expiration dates for documents that are uploaded by the end-user.

In some example embodiments, upon selecting a date in the calendar 326, the system 100 may prompt the end-user to create a reminder (e.g., for email communication, SMS-message, and other methods of notification accessible to and specified by the end-user). The system 100 may display content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some example embodiments, when adding a new vendor product (310), the system 100 may present the end user with a list of products (e.g., table 302; FIG. 3B). The list may include products (e.g., all products) associated with the financial institution, including those that are not currently being managed by any of the end-users of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, moderate, high, and unknown (as corresponding to the risk level 304). Alternatively, the risk level may be an input from the risk-assessment module 214.

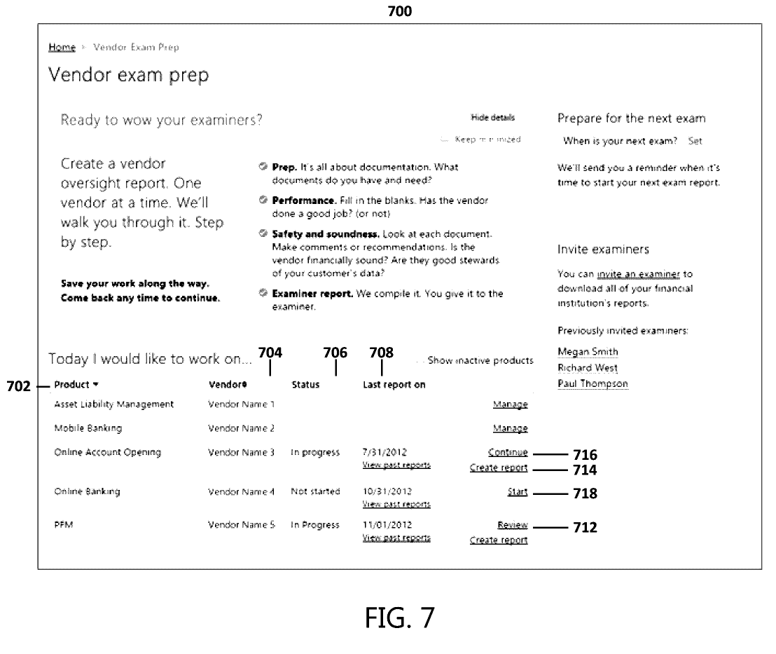

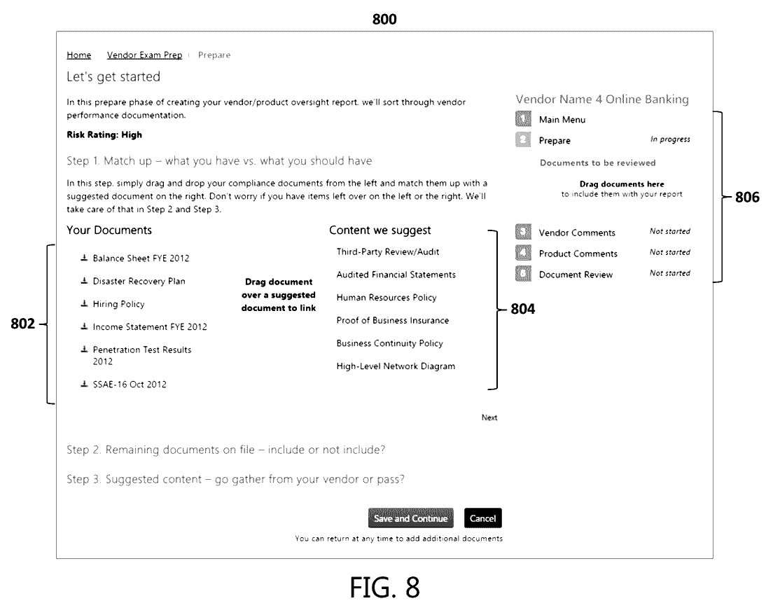

In some implementations, the risk-levels 304 and 308 may be used to determine a suggested document 320 (e.g., FIG. 8) in the examination-preparation area 322 (e.g., FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's functions (e.g., upload contract, add notes and reminders, save email conversation, and document events), though may not change or undo any of the actions performed by the end-user. Each of the vendor products may be assigned a different point of contact (e.g., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepares the contract for review by the end-user. The system 100 may use an aliases table. Examples of tools utilized by the third-party to analyze and prepare the contract are described in Appendices E and F of the U.S. Provisional Patent Application No. 61/805,066, which is incorporated by reference herein in its entirety. Moreover, management of contracts is described in further detail below.

FIG. 3C illustrates an interface 300C displaying a list, table or the like of contracts. As shown in FIG. 3C, a list of contracts 306 is displayed in corresponding rows of a table, with columns representing fields and/or parameters associated with each contract, including: vendor, product, notification deadline, expiration and available actions. The interface 300C includes buttons 308 for filtering the contracts in the contract list 306 based on product ownership and contract availability, using corresponding buttons. The interface 300C also includes a listing of the number of contracts on file that are being displayed as a result of a filtering or search operation (324), which is shown in FIG. 3C as 21/0 contracts.

Vendor Dashboard

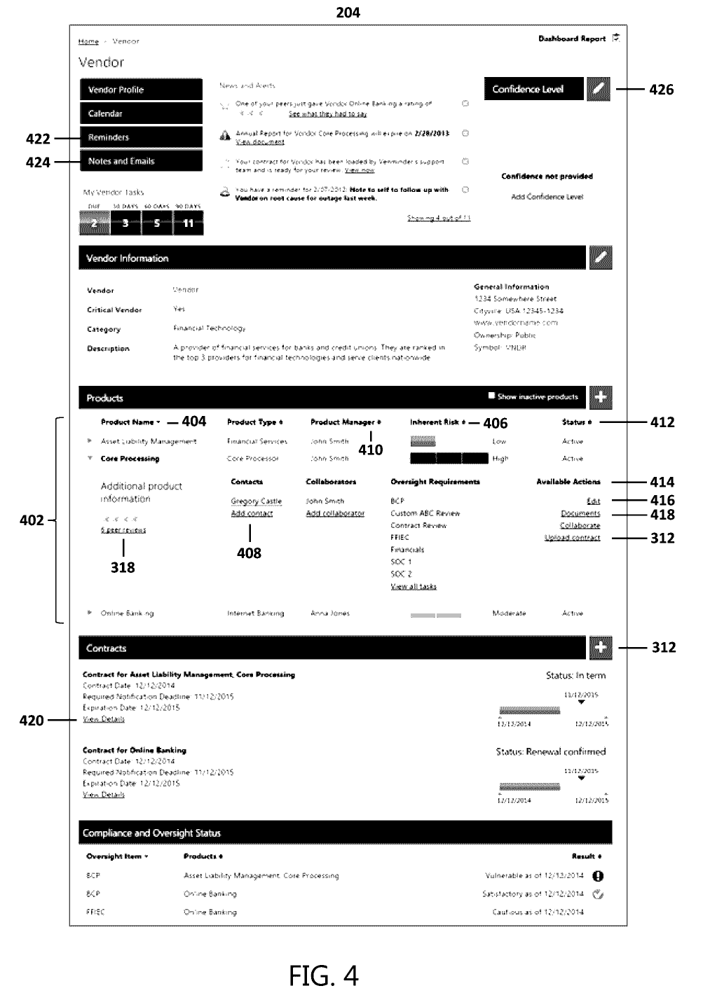

FIG. 4 is a vendor dashboard 204 in accordance with an example embodiment. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents, the function to prepare for an examination, and the function to view and manage reviews for a given vendor products.

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, vendor contact information 408, an assigned product manager (e.g., of the financial institution) 410, a status indicator of the product 412, and actionable tasks 414 associated with a given product. The actionable tasks 414 may allow an end-user to edit given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon or in response to a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reached | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states, for example, “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been cancelled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also send the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g., electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information. In some example embodiments, the vendor dashboard 204 may include a section to record confidence levels 426. The user can record values of ‘Highly Confident’, ‘Somewhat Confident’ and ‘Not Confident’. The system records a history of confidence changes over time for reporting purposes.

Document Storage

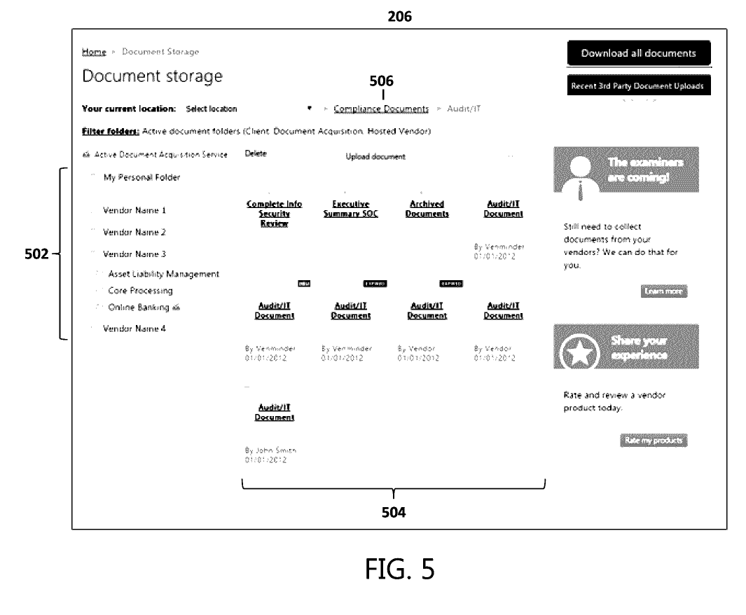

FIG. 5 is an example document storage page 206 in accordance with an example embodiment. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders (or subfolders) relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

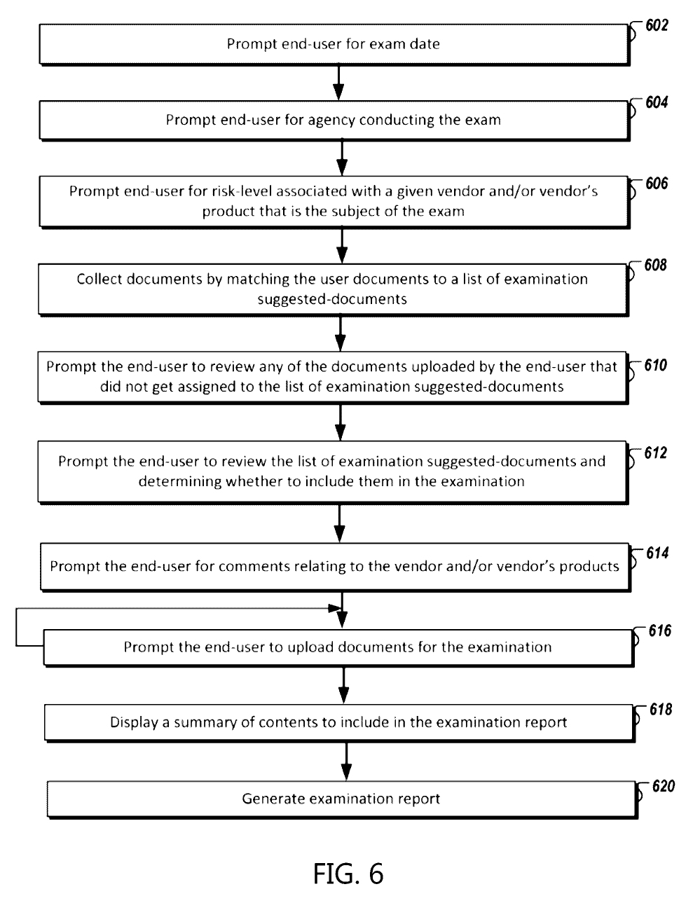

FIG. 6 is an example workflow of the system 100 to guide an end-user to prepare a vendor oversight report associated with one or more selected vendor products in accordance with an example embodiment. The workflow may be referred to as “Exam Prep”. The Exam Prep may be used to assist and guide the users of a financial institutions to prepare, for example, for their annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notifications (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an example embodiment. The workspace 700 may display a list of products 702. For each of the products 702, the workspace 700 may display the vendor name (704), the status of the examination (706), the last reported date (708), and actionable tasks (710).

The last reported date 708 may be, for example, the last time a report was created or the last time the product was examined. The status of the examination (706) may include “complete”, “in progress”, and “not started.” A list of the examination statuses is shown in Table 2.

TABLE 2

| Status | Description | Action |
|---|---|---|
| Complete | All steps have been completed | Review, Preview report |
| In progress | Started but not all steps | Continue, Preview report |
| | completed | |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined options. The pre-defined list may be selected based on the risk-level associated with the given product or vendor subject to the examination.

FIG. 8 is an example workspace 800 for matching collected end-users' documents to a list of suggested documents in accordance with an example embodiment. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-process, or ready to start) in the workflow.

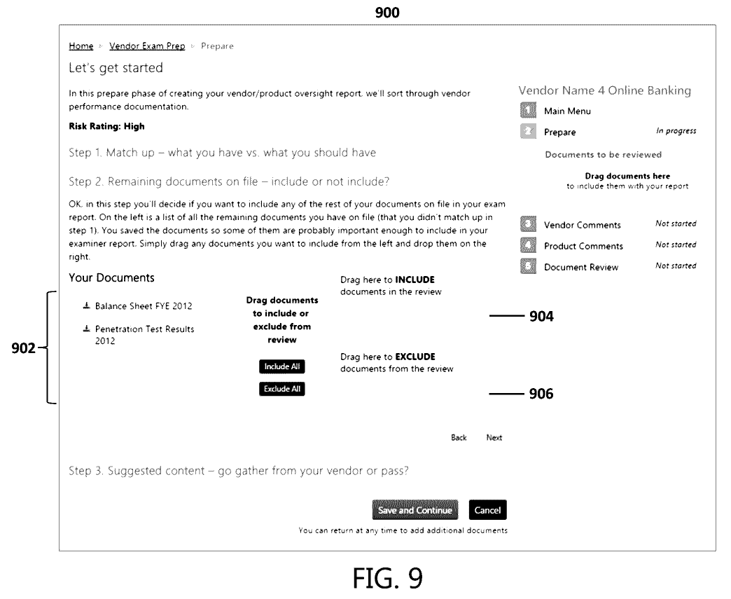

Referring back to FIG. 6, in some implementations, the method 600 may include prompting the end-user to review any of the collected documents uploaded by the end-user that were not assigned to the list of the examination suggested-documents (step 610). FIG. 9 is an example workspace 900 for prompting the end-user to review the unassigned documents 902 that have been collected to the document storage page 206, but have not been assigned in FIG. 8. In some implementations, the system 100 may prompt the end-user to identify each of the unassigned documents as either to include (904) or exclude (906) from the report/examination.

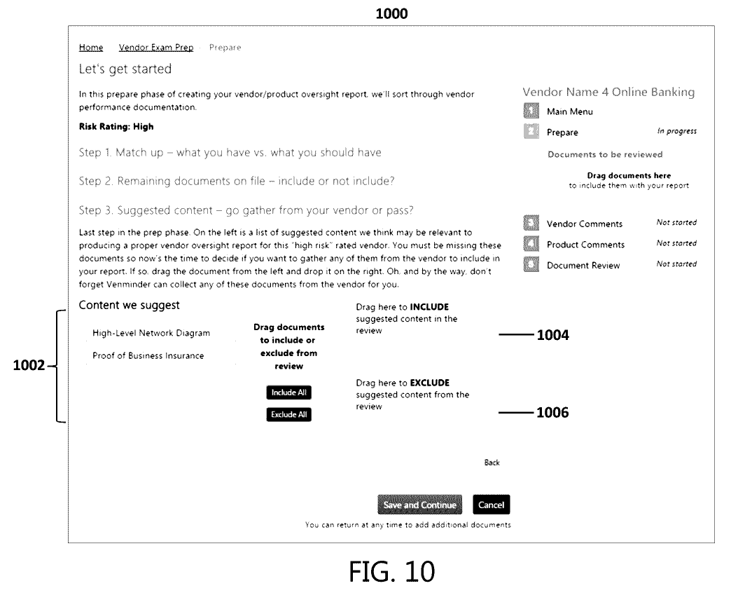

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor products that is being examined.

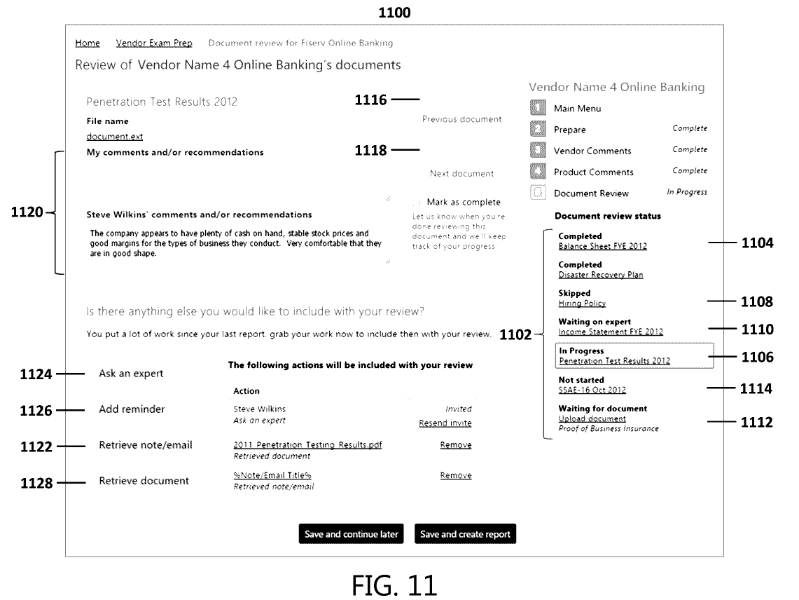

Still looking at FIG. 6, in some implementations, the method 600 may include displaying (step 614) all of the documents that have been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an example embodiment. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document | |
|---|---|
| Status-Label | Description |
| Not Started | Included in exam but the user has not reviewed it |
| Waiting on expert | Expert has been invited but no response provided |
| Waiting for documents | Document type is included in exam but document |
| | has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. In turn, the system 100 may allow (e.g., exclusively) the co-worker and/or expert to view and provide comments, for the vendors and/or vendor product, to which they were asked to comment on. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc.), and an identity of the end-user and/or product manager that performed the upload. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may, in turn, add documents to the examination preparation process from the document storage page 206.

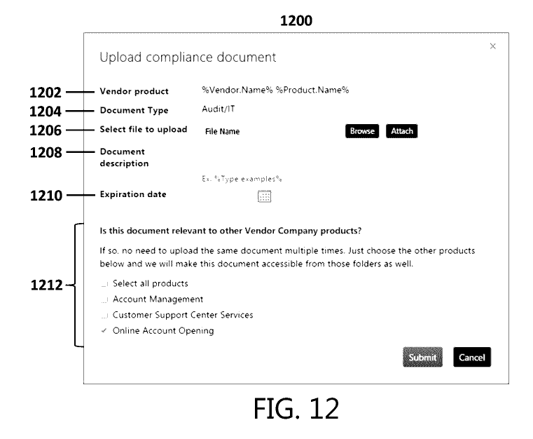

Referring back to FIG. 6, in some implementations, the method 600 may include prompting the end-user to upload documents for the examination (step 616). FIG. 12 is an example workspace 1200 for uploading a document or documents to be attached and included in the examination in accordance with an example embodiment. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be include in the report.

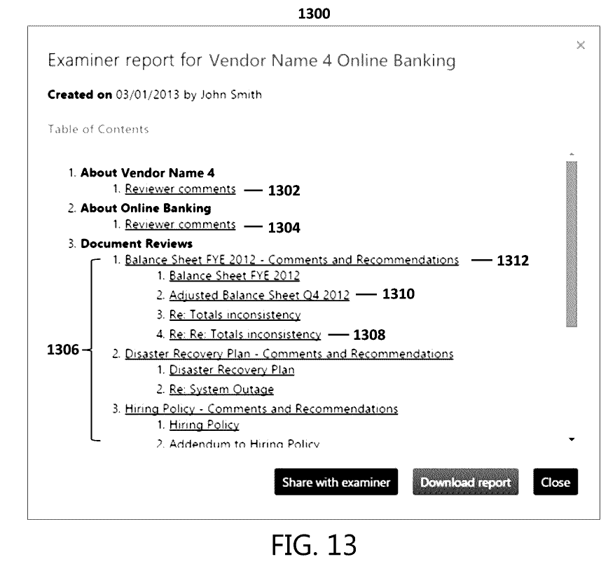

With reference to FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an example embodiment (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section where the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (e.g., in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

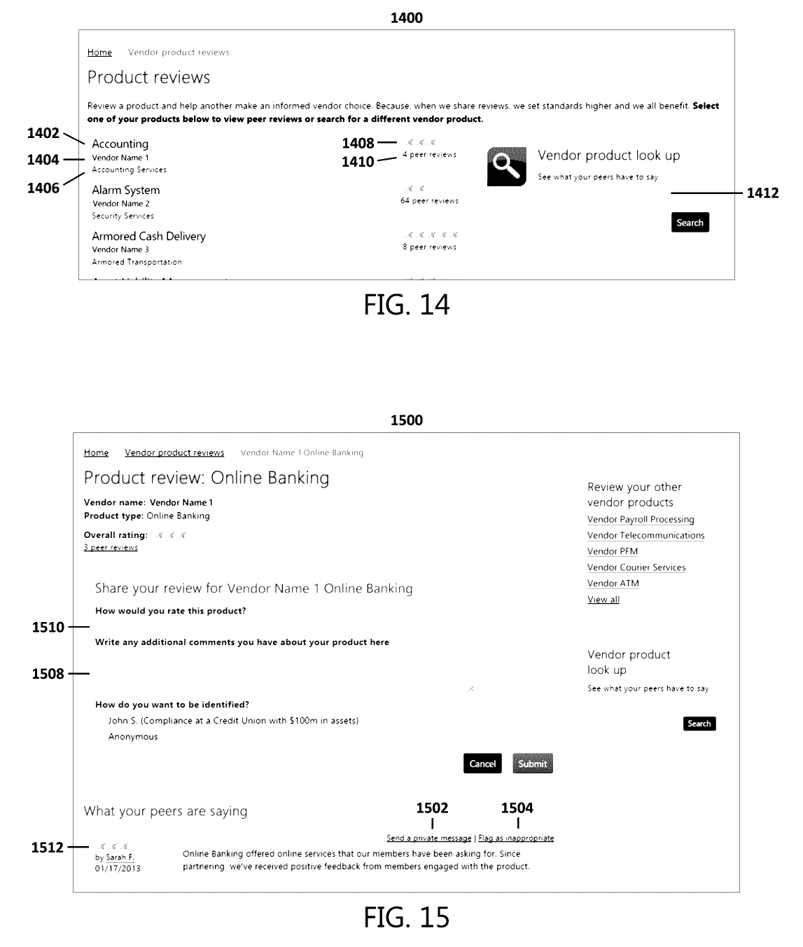

FIG. 14 is an example workspace 1400 to review vendor products in accordance with an example embodiment. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value (1408), and an indication of the number of reviews (1410). In some example embodiments, the system 100 may provide a search tool (1412). In some implementations, the system 100 may also provide a rating/review module for a given vendor.

FIG. 15 is an example display 1500 for viewing product reviews in accordance with an example embodiment. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may be a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

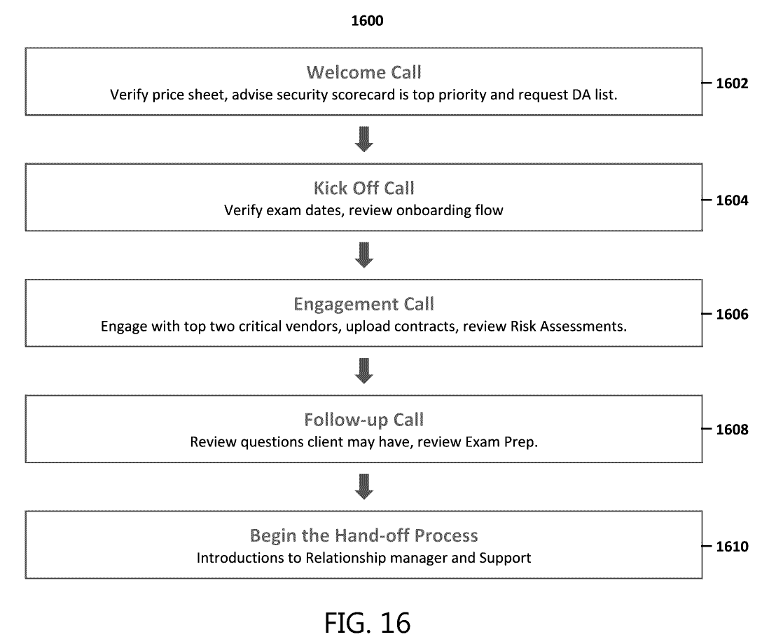

FIG. 16 is an example flowchart of a client onboarding process 1600 in accordance with an example embodiment. At step 1602, a welcome call, meeting or communication is executed to verify a price sheet, provide advice regarding security scorecards (e.g., as a top priority), and request a DA list. In turn, at step 1604, a kick-off call or other communication is executed to, for example, verify exam dates and review onboarding flow.

In turn, at step 1606, an engagement call or other communication is executed to engage with top (e.g., top two) critical vendors, upload contracts and review risk assessments. At step 1608, a follow-up call or other communication is performed to review questions that a client may have and review Exam Prep. At step 1610, the hand-odd process is imitated, where introductions to relationship manager and other support is executed.

Risk-Assessment Module

In another aspect of an embodiment, the system 100 provides a risk-assessment module 1700 (e.g., FIG. 2, 214) that may allow the end-user to rate the vendor products and/or vendors in the areas of Information Access, Operational and Financial Dependency and Regulatory Exposure. To this end, the system 100 may provide a graphical user interface configured to display one or more prompts for user entries associated with a risk assessment of a given vendor product where the user entries are in response to a set of questionnaires.

In some implementations, the system 100 stores libraries of pre-defined questionnaires that the end-user can search. In some implementations, the libraries may be defined for a given financial institution. To this end, the libraries may be accessible to end-users associated with the financial institutions. Once a template questionnaire is selected and displayed, the system 100 may allow the end-user to add questions to the template questionnaires. The questionnaires are used to solicit a risk rating about an aspect of the product. The ratings may be aggregated to provide an aggregated risk rating for the product. The aggregated risk rating may be employed in the examination preparation and examination report.

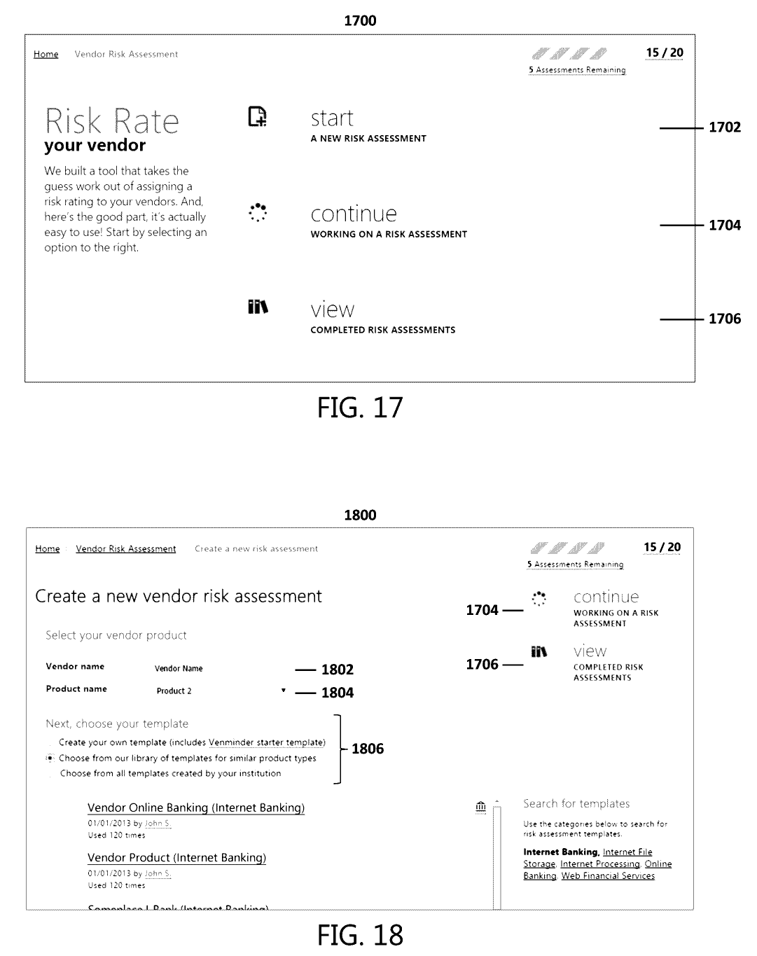

FIG. 17 is an example workspace 1700 for performing a risk assessment of a vendor product in accordance with an example embodiment. The workspace 1700 provide prompts for a user to create a new risk assessment (1702), to continue work on a risk assessment that is in progress (1704), and to view a completed risk assessment (1706).

FIG. 18 is an example workspace 1800 to initiate a new risk assessment of a vendor product in accordance with an example embodiment. The workspace 1800 may include a prompt for a vendor name (1802) and a product name (1804).

In some implementations, the system 100 may maintain a list of existing and completed risk assessment. The system 100 may determine whether a request to initiate the risk assessment for the given vendor product is a duplicate of an existing risk-assessment evaluation or a completed risk-assessment evaluation. To this end, the system 100 may use the list to prevent duplicate risk-assessment evaluations from being initiated for a given vendor product for a given end-user and financial institution.

The workspace 1800 may provide the end-user with a prompt (1806) to start i) a new template for a given risk area (e.g., Information Access, Operational and Financial Dependency and Regulatory Exposure), ii) a template used by the end-user the last time a risk assessment was performed, and iii) a template created by other end-users that is accessible to the end-user.

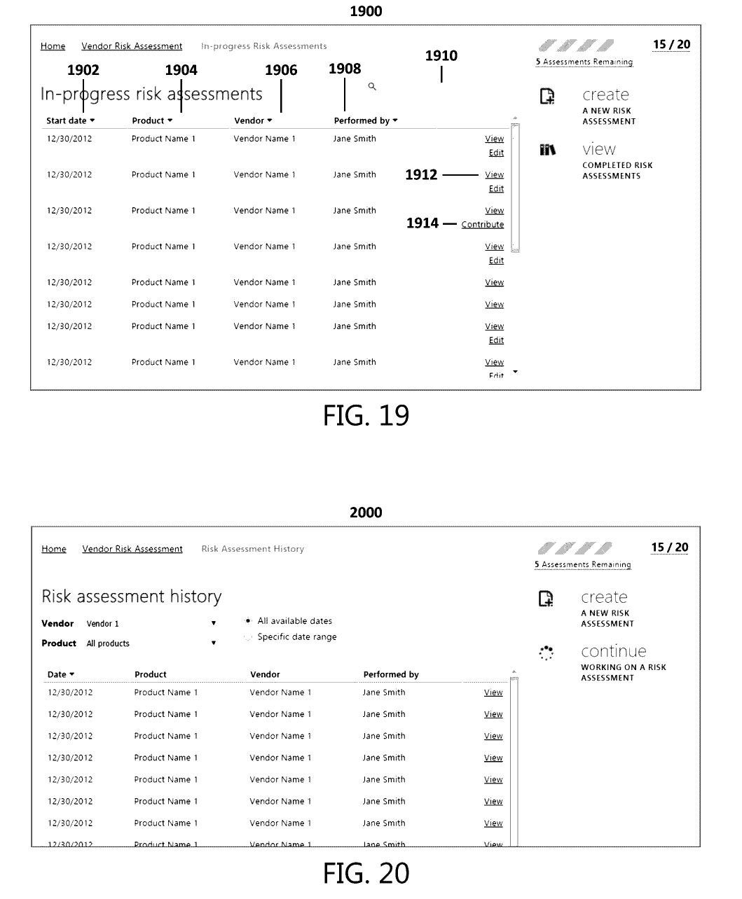

FIG. 19 is an example workspace 1900 to view risk-assessment evaluations that are in-progress in accordance with an example embodiment. The workspace 1900 may display all of the risk-assessment evaluations of vendor products that are currently in-progress by a given financial institution. The workspace 1900 may display a start date associated with a given risk-assessment evaluation (1902), a product name (1904), a vendor name (1906), and an identifier of the end-user that initiated the risk-assessment evaluation (1908). The workspace 1900 may also allow the end-user to view an identifier of other end-users that may edit a risk assessment or have viewing permission of the risk assessment results (1912). The workspace 1900 may also allow the end-user to invite other end-user/product managers to contribute to a given risk-assessment evaluation (1914).

In some implementations, the workspace 1900 may include a search tool 1910 (e.g., search bar, search area) for searching among the vendors or products.

FIG. 20 is an example workspace 2000 to view completed risk-assessment evaluations in accordance with an example embodiment. The workspace 2000 allows an end-user to view a list of all of the completed risk assessments by a given financial institution for a given product or vendor. The workspace 2000 allows the end-user to search for past evaluations, for example, based on the vendor name, the product name, and date that the assessment was initiated or completed.

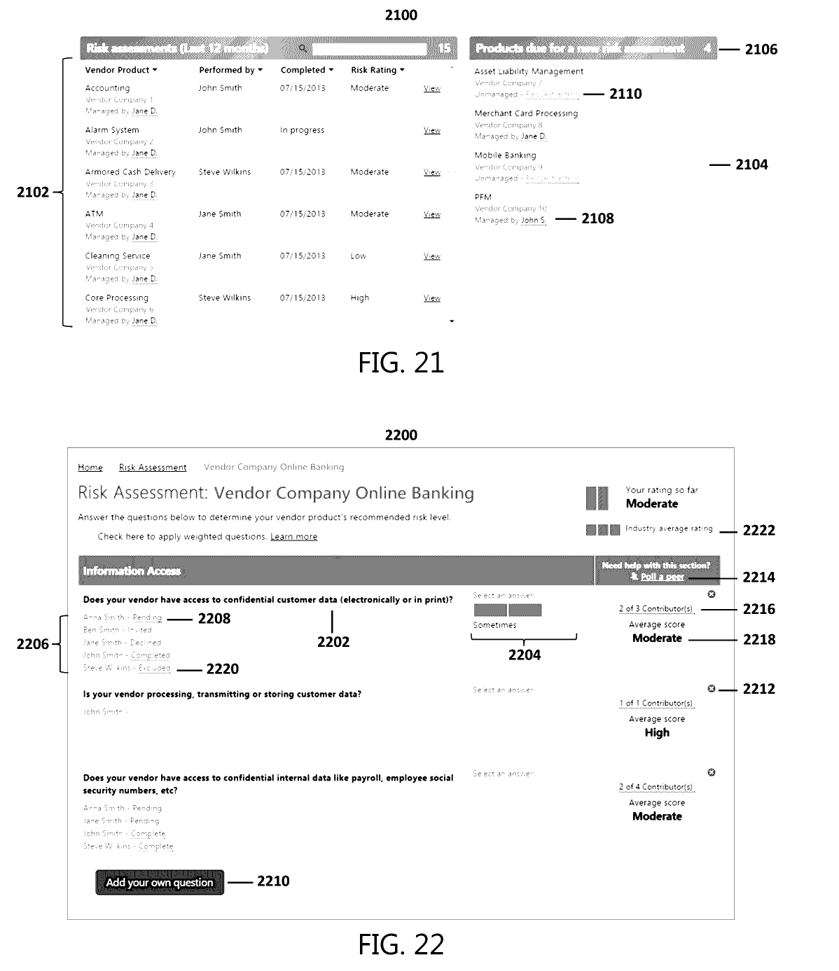

FIG. 21 is an example dashboard 2100 to manage risk-assessment evaluations of vendors and vendor products in accordance with an example embodiment. In some implementations, the dashboard 2100 may display a summary of risk assessments that are in-progress or have been completed (2102) within the last 12 months. The dashboard 2100 may display a list of vendor products that have never had a risk assessment completed (2104). The dashboard 2100 may display a list of vendor products that are due for a risk assessment (2106) (for example, the product had an assessment performed and/or completed in the past).

The dashboard 2100 may display product managers (2108) or indicate that a product is not managed (2110).

FIG. 22 is an example risk assessment workspace 2200 in accordance with an example embodiment. The workspace 2200 may display a set of questions (2202) and a prompt (2204) for the end-user to select a reply, which may consist of a risk level rating (e.g., low, moderate, high). In some implementations, the workspace 2200 may include prompts (2214) to allow the end-user to invite or poll one or more peers to contribute to the evaluation/assessment.

The workspace 2200 may display a summary rating (2218) for each of the risk assessment questions. The summary rating may be an average (e.g., mean), a mode, or a weighted sum (in which certain “expert” collaborators are assigned higher weights). In some implementations, the workspace 2200 may display a list of collaborators (2206) and their progress in providing their comments (2208). The workspace 2200 may provide a prompt (2216) for the end-user to see individual feedback or input from a given peer or collaborator. In some implementations, the workspace 2200 may allow the end-user to exclude certain peer evaluations from the summary rating (2220). In some implementations, the end-user may include or exclude a certain peer evaluation by selecting the displayed status (e.g., 2220). The workspace 2200 may display an industry rating (2222) for a given vendor product.

The workspace 2200 may include prompts to allow the end-user to add additional questions to the workspace (2210) or remove questions from the workspace (2212).

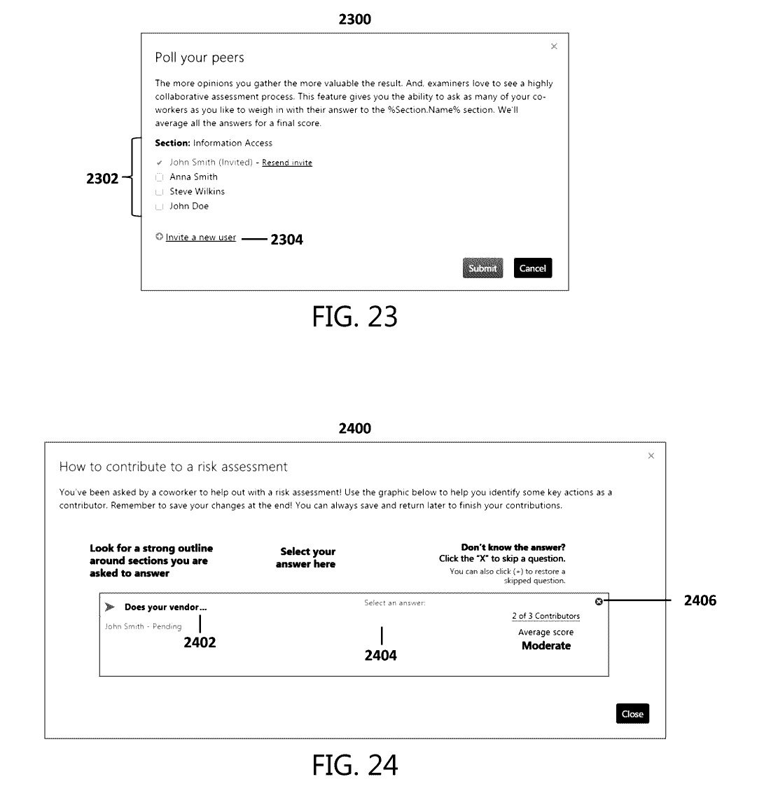

Upon selection of the prompt to invite or poll a set of peers to contribute to the evaluation/assessment (2214), the system 100 may provide a list of peers for the end-user to select. FIG. 23 illustrates an example invitation-workspace 2300 to invite peers to contribute to a risk-assessment evaluation in accordance with an example embodiment. The workspace 2300 may include a list 2302 of peers who are registered (e.g., another end-user) with the system 100. The workspace 2300 may provide a prompt (2304) for contact information for a new user.

FIG. 24 is an example request message 2400 for comments from a collaborator to a given risk-assessment evaluation in accordance with an example embodiment. The request message 2400 may display the question (2402) as presented in the risk-assessment evaluation and a prompt (2404) for a reply. The request message 2400 may also provide a prompt (2406) to decline to provide a response and/or feedback.

In another aspect of the disclosure, a business model provides for securing subscriptions from financial institutions for a financial institution/vendor relationship management system. For example, free online tools are offered for vendors to use to securely distribute their sensitive compliance documentation to financial institution clients in a vendor-controlled fashion. When vendors distribute compliance documents through the system, they invite their financial institutions to use the system to retrieve them (e.g., free of charge to the financial institution). The financial institution is given an opportunity to use the system to manage one or more of their vendor products, including a certain amount of storage space. The financial institutions can then upgrade online to various individual user-based packages by credit card, or a system for enterprise-wide, more extensive usage. The enterprise package may be sold to a financial institution, where storage space is shared across the institution, and high volumes of vendor products, contracts, etc. can be managed. The enterprise package may also provide the institution with an unlimited number of users accessing the system. The package may provide the financial institution with administrative controls and executive-level dashboard. Examples of such subscriptions and online tools are provided in Appendices B-D and G of the U.S. Provisional Patent Application No. 61/805,066, which is incorporated herein by reference in its entirety.

In another example, as shown in FIGS. 19-20, the system 100, in some implementations, provides a pre-defined number of complimentary risk assessments for vendors and/or products that a given end-user or financial institution may perform. The system 100 may display a number of remaining complimentary risk assessments to promote an end-user to evaluate and use the tool.

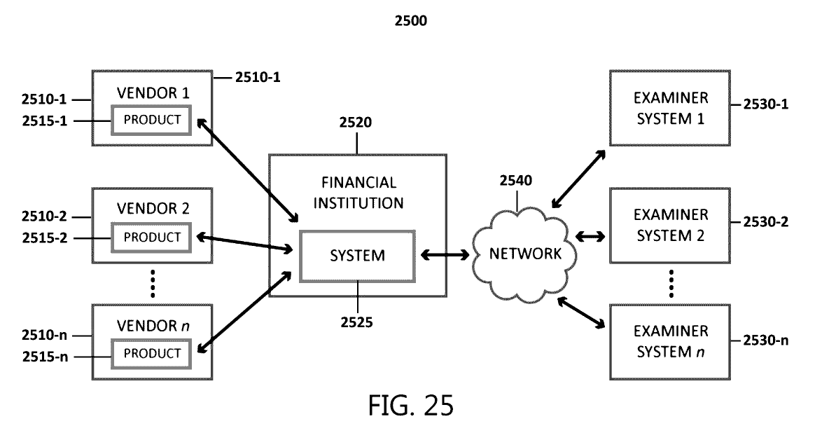

FIG. 25 is a diagram of a system 2500 for managing examination reports, in accordance with an exemplary embodiment. The system 2500 includes vendors 2510-1, 2510-2, . . . , and 2510-n (collectively “vendors” or “2510”). Each of the vendors includes a corresponding product 2515-1, 2515-2, . . . , and 2515-n (collectively “products,” “vendor products,” or “2515”), respectively. The vendor products 2515 are communicatively coupled, accessed and/or used by the financial institution 2520. The financial institution 2520 (e.g., client of the vendor) include a system (or set of systems) 2525, which include one or more networks, storage devices, computing devices, and the like, which are interconnected. In some example implementations, the system 2525 includes user computing devices connected thereto, via which users access the system 2525 and/or communicate with other entities and/or systems (e.g., examiner systems). Users include product users, administrators (e.g., enterprise administrators), vendors and/or product managers, collaborators, experts, executives, and the like.

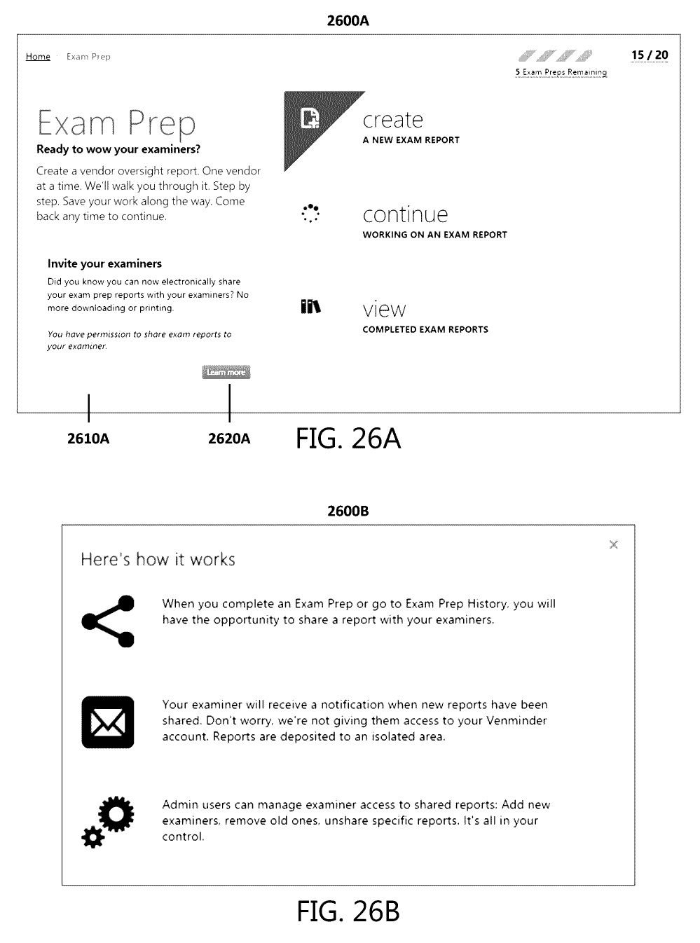

In some example implementations, the system 2525 includes (e.g., stores) user and/or examiner information including names, e-mails, telephone numbers, user names, passwords, security questions and answers, and the like. In some example implementations, the system 2525 may, among other things, collect, retrieve, store, manage, transmit, and/or provide access to examination reports, as described in further detail below, for example, with reference to FIGS. 26A-31 and Appendix A of U.S. Provisional Patent Application No. 62/140,551, filed on Mar. 31, 2015, the contents of which are incorporated herein by reference in their entireties. The examination reports are reports corresponding to examinations completed and/or presented by users (e.g., via the users' corresponding computing devices) associated with a financial institution (e.g., financial institution 2520). The examinations are, for example, examinations with, administered by, and/or managed by government agencies, regulatory bodies and/or auditing services. In some example implementations, the system 2525 collects and/or stores examination reports after examinations have been administered. The examination reports are stored at a memory, server, database or the like corresponding to the system 2525. The examination reports are stored at third party systems and/or systems of examining authorities, and retrieved on command by the financial institution 2520, for example, when access is requested by an examiner. That is, for example, a financial institution system 2525 stores part or all of an examination report, or a location (e.g., link, web address, storage location) of an examination report.

In turn, the system provides, to examiners, access to all or a portion of the collected and/or stored examination reports. The examiners accesses the examination reports using corresponding examiner systems 2530-1, 2530-2, . . . , and 2530-n (collectively “examiner systems” or “2530”), via a network 2540. It should be understood that the network 2540 may be a single communications network or a set of interconnected communications networks. In some example implementations, the examiner systems 2530 may access the examination reports via a website, application, widget, or the like, which provide (e.g., display, graphically render) graphical user interfaces (e.g., FIGS. 26A-31), for viewing, downloading and/or printing (or the like) of examination reports.

FIG. 26A illustrates a graphical user interface 2600A (e.g., exam prep home page) for managing examination reports, in accordance with an exemplary embodiment. The graphical user interface 2600A is accessed by a user associated with a financial institution (e.g., financial institution 2520) via the user's computing device, for example, via a webpage.

The graphical user interface 2600A includes selectable areas (e.g., buttons, links, graphical user interface regions) for creating examination reports, to continue working on examination reports, and for viewing completed examination reports. The graphical user interface 2600A includes information (e.g., messages) 2610A regarding the sharing of examination reports with examiners. For example, the information 2610A indicates sharing permissions associated with the user of the graphical user interface 2600A. Sharing permissions include whether or not the user shares examination reports with examiners. For example, if a user does not have permission to share examination reports, the information 2610A includes “Ask your Admin for examiner sharing permissions” and/or buttons (or the like) for requesting permissions to share examination reports. If a user does have permission to share examination reports, the information 2610 includes “You have permission to share reports to your examiners” or the like.

The graphical user interface 2600A may also include a button 2620A (or the like) (e.g., “Learn More”) for accessing additional information regarding the sharing of examination reports with examiners. Clicking, selecting, tapping, or the like of the button 2620A causes a graphical user interface (e.g., FIG. 26B, graphical user interface 2600B) to be displayed (e.g., graphically rendered).

FIG. 26B illustrates a graphical user interface 2600B (e.g., “here's how it works”) for accessing information regarding the sharing of examination reports with examiners, in accordance with an exemplary embodiment. The graphical user interface 2600B is accessed by a user associated with a financial institution (e.g., financial institution 2520) via the user's computing device, for example, by clicking a “Learn More” button (e.g., FIG. 26A, 2620A) in an exam prep home page (e.g., FIG. 26A, graphical user interface 2600A). The graphical user interface provides information, for example, regarding how examination reports can be shared, how examiners can access shared examination reports, and/or how sharing settings can be controlled.

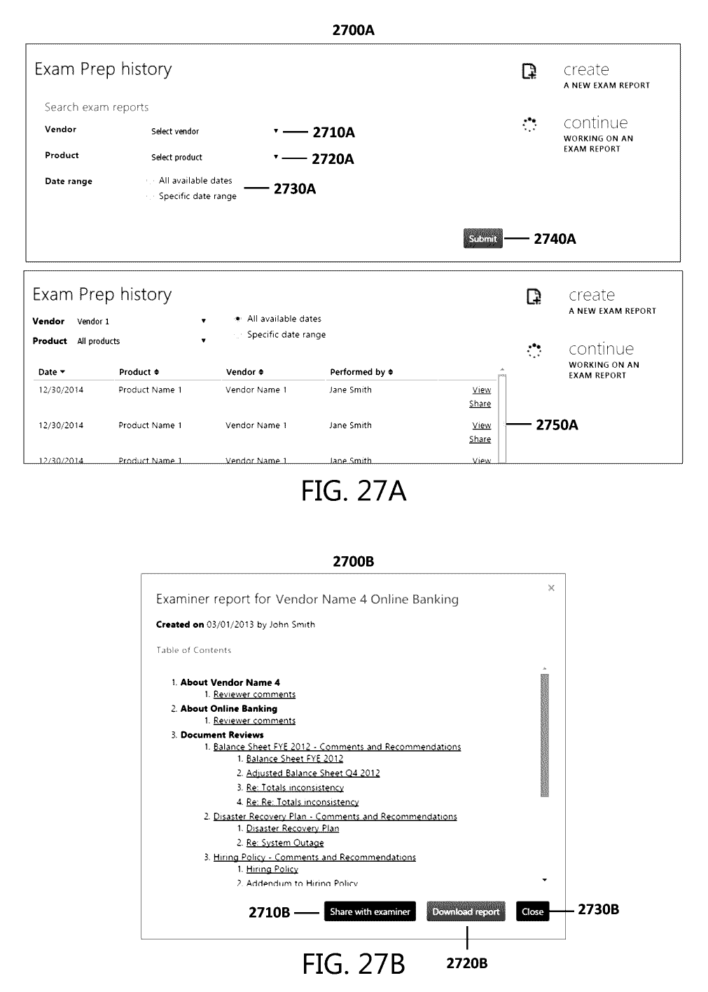

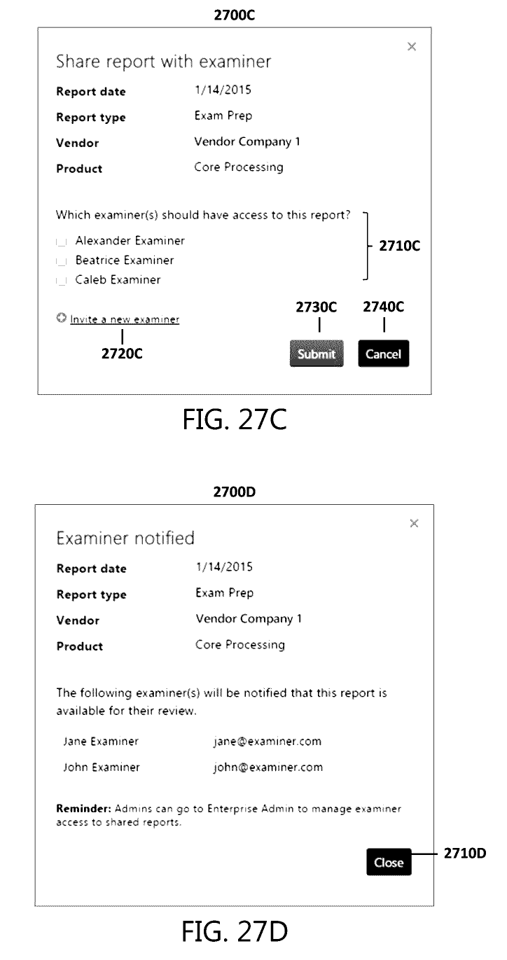

FIG. 27A illustrates a graphical user interface 2700A for managing examination reports, in accordance with an exemplary embodiment. The graphical user interface 2700A is accessed by a user associated with a financial institution (e.g., financial institution 2520) via the user's computing device, for example, via a webpage. The graphical user interface 2700A is used to search, view and/or access examination reports. The examination reports to be viewed and/or accessed can be filtered by vendor (e.g., via vendor drop down menu 2710A), by product (e.g., via product drop down menu 2720A), and by date range (e.g., via data range options 2730A). The graphical user interface 2700A includes a button or the like 2740A which, when selected (e.g., clicked, tapped) causes a list of examination reports to be retrieved, collected, and/or displayed in an examination reports table 2750A, in accordance with the filtering options 2710A, 2720A and/or 2730A.

The examination reports table 2750A lists information associated with examination reports. In some example implementations, the examination reports are reports corresponding to the user of the graphical user interface 2700A, or examination reports corresponding to users of the financial institution that are associated with the user of the graphical user interface 2700A (e.g., team members, subordinates, etc.)

For each examination report, the examination reports table 2750A displays, for example, the date on which an examination report was created (e.g., “Date”), the product associated with the examination report (e.g., “Product), the vendor of the product associated with the examination report (e.g., “Vendor), the name of the user associated with the examination report (e.g., the examinee, taker of the examination) (e.g., “Performed by”), and options (e.g., button, link) to view (e.g. “View”) and share (e.g., “Share”) the examination report. The examination reports table 2750A may be sorted by field (e.g., date, product, vendor, user). In some example implementations, the share option for an examination report may not be displayed or, if displayed, is deactivated, if the user does not have permissions to share that examination report. Clicking, selecting, tapping, or the like of the share option of an examination report causes a sharing workflow to be initiated, including displaying a graphical user interface (e.g., FIG. 27B, graphical user interface 2700B) to be displayed (e.g., graphically rendered).

FIG. 27B illustrates a graphical user interface 2700B for confirming the sharing of an examination report, in accordance with an exemplary embodiment. The graphical user interface 2700B includes information identifying the product and vendor associated with the examination report to be shared (e.g., “Fisery Online Banking”), a date on which the examination report was created (e.g., “03/01/2013), and the user associated with the examination report (e.g., “John Smith”). The graphical user interface 2700B also includes a table of contents with links for accessing information (e.g., documents, comments) regarding (1) the vendor, (2) the product, and/or (3) other documents associated with the examination and/or examination report. Selecting the links for documents, notes, comments, and/or the like displayed in the table of contents causes the corresponding document, note, comment, and/or the like to be loaded, displayed, graphically rendered, downloaded, or the like.

The graphical user interface 2700B also includes buttons or the like for sharing an examination report with an examiner (e.g., 2710B, “Share with examiner”), downloading a report (e.g., 2720B, “Download report”), and/or canceling the sharing of the examination report (e.g., 2730B, “Close”). More specifically, selecting (e.g., clicking, tapping) the button 2710B causes a graphical user interface (e.g., FIG. 27C, graphical user interface 2700C) to be displayed (e.g., graphically rendered). In some example implementations, selecting the button 2710B causes the report to be shared with the examiner, as described in further detail below, for example, with reference to FIGS. 27C and 27D. Selecting the button 2720B causes the examination report to be downloaded for the user. Downloading the examination report includes retrieving the examination report from storage (e.g., storage by the financial institution system or examining authority's system) and (1) causing the examination report to be displayed on the computing device of the user, and/or (2) causing the examination report to be stored in the computing device of the user. Selecting the button 2730B causes the process of sharing the examination report to be cancelled. In some example implementations, a home page (e.g., graphical user interface 2600A) or examination report history page (e.g., graphical user interface 2700A) may be caused to be displayed. That is, in some example implementations, the computing device corresponding to the user may be returned to a previously-displayed graphical user interface.

FIG. 27C illustrates a graphical user interface 2700C for sharing an examination report with an examiner, in accordance with an exemplary embodiment. The graphical user interface 2700C includes information identifying the examination report date (e.g., “03/19/2015”), the name of the vendor associated with the examination report (e.g., “1st Bank Yuma”) and/or the vendor's product associated with the examination report (e.g., “Enterprise”).

The graphical user interface 2700C also includes a confirmation, question, prompt, or the like, identifying and/or confirming information (e.g., name, e-mail) 2710C regarding the examiner with which the report is to be shared (e.g., “Mrs. Examiner,” “examiner@domain.com”). A checkbox next to the examiner information 2710C can be used to indicate whether or not the examination report is to be shared with an examiner. For example, clicking a checkbox next to an examiner's information indicates that the report is to be shared with that selected examiner. On the other hand, unchecking the checkbox indicates that the examination report is not to be shared with that examiner. The graphical user interface 2700C also includes a link, command, prompt or the like 2720C, which, if selected, causes a prompt, window, graphical user interface, or the like, to be loaded, displayed and/or graphically rendered, and can be used to invite an examiner (and/or examiner system) with which to share a report.

The graphical user interface 2700C includes buttons to submit (e.g., 2730C, “Submit”) and cancel (e.g., 2740C, “Cancel”) the examination sharing transaction. That is, selecting (e.g., clicking, tapping) the button 2730C causes an examination sharing request to be transmitted based on the information included in the graphical user interface 2700C (e.g., report date, vendor, product, examiner name and e-mail). In one example implementation, selecting the button 2730C causes the examination sharing request to be sent to the financial institution system (e.g., FIG. 1, financial institution system 2525) and, in turn, causes a notification and/or the examination report to be sent and/or made available to the examiner. Moreover, in some example implementations, selecting the button 2730C causes a sharing confirmation graphical user interface (e.g., FIG. 27D, graphical user interface 2700D) to be displayed and/or graphically rendered. Selecting the button 2740C causes the process of sharing the examination report to be cancelled and, in some example implementations, causes the user to be returned to a previously-displayed graphical user interface.

FIG. 27D illustrates a graphical user interface 2700D for confirming sharing of an examination report, in accordance with an exemplary embodiment. The graphical user interface 2700D includes information identifying the examination report date (e.g., “01/14/2015”), the name of the vendor associated with the examination report (e.g., “Fiserv”) and/or the vendor's product associated with the examination report (e.g., “Core Processing”).

The graphical user interface 2700D may also include information confirming the examiner or examiners with which the examination report is to be shared with (e.g., “Jane Examiner” and “jane@examiner.com”). Moreover, the graphical user interface 2700D includes reminder information for the user, for example, identifying options that an administrator can take with regard to sharing of examination reports (e.g., managing access). The graphical user interface 2700D includes a close button (e.g., 2710D, “Close”), which, if selected (e.g., clicked, tapped) causes the graphical user interface 2700D to be closed, exited, or the like.

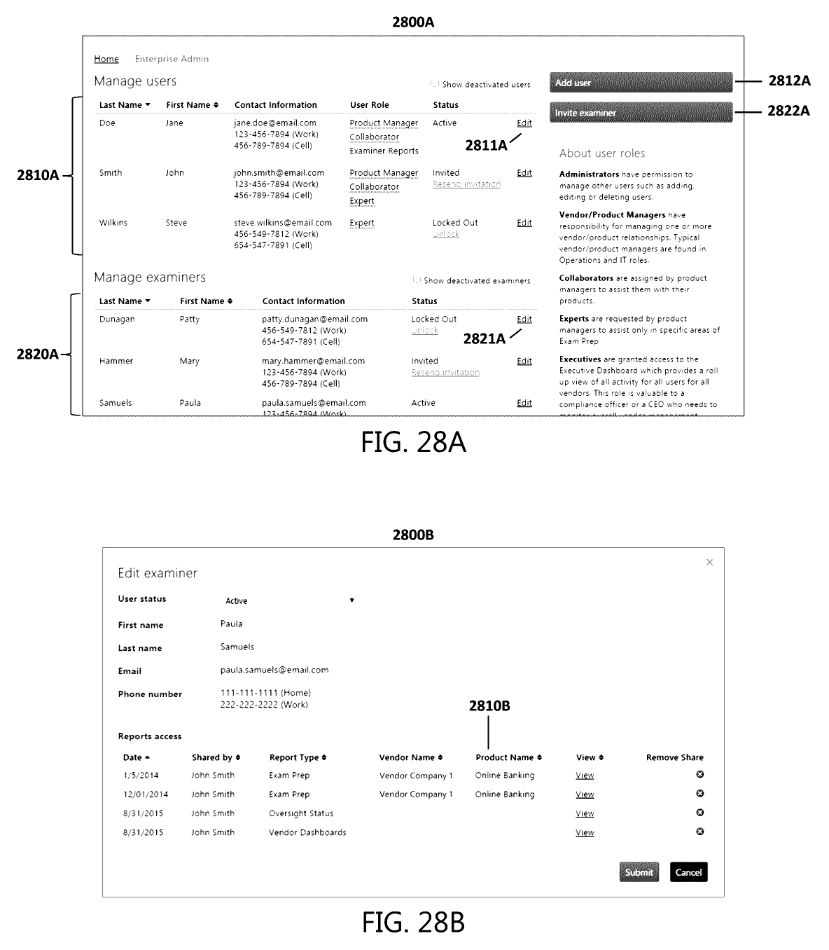

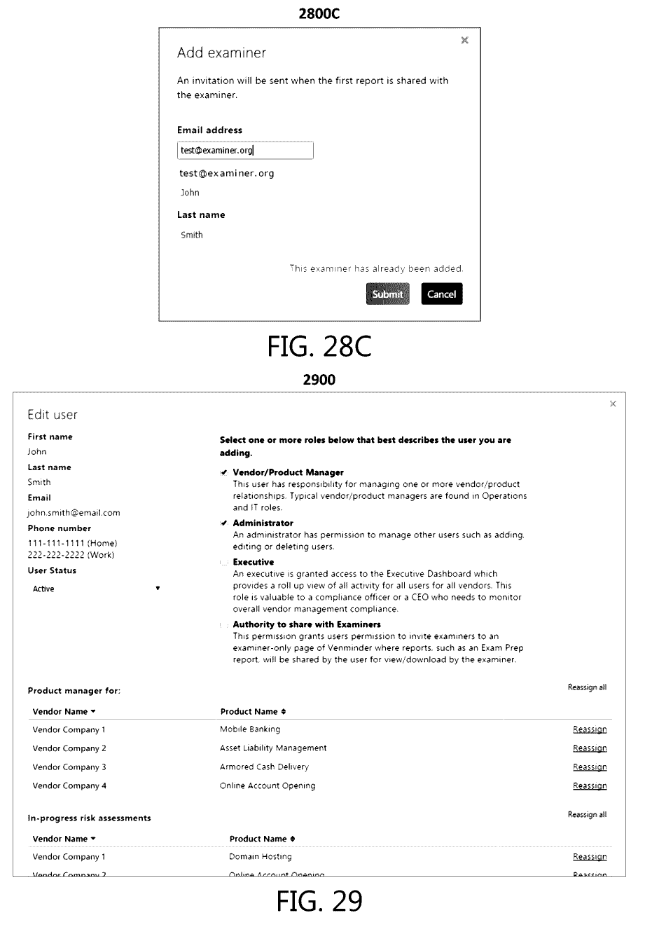

FIG. 28A illustrates a graphical user interface 2800A for managing users and examiners, in accordance with an exemplary embodiment. The graphical user interface 2800A includes a section (e.g., area, panel, region) 2810A for managing users, and a section 2820A for managing examiners. The graphical user interface 2800A also includes a region describing users (e.g. “About user roles”), which includes users, administrators, product managers, vendors, collaborators, experts, executives and users with authority to share with examiners. The graphical user interface 2800A also includes buttons (e.g., commands, links) for adding users (e.g., 2812A) and/or for adding examiners (e.g., 2822A). In some example implementations, selecting (e.g., clicking, tapping) the button 2812A or the button 2822A causes a process to add users and/or add examiners, respectively, to be initiated. Adding an examiner includes causing a graphical user interface (e.g., FIG. 28C, graphical user interface 2800C) to be loaded, displayed and/or graphically rendered.

In some example implementations, the user management section 2810A includes a table displaying users. The table displays active users, as well as deactivated users, for example, in the event that a checkbox to view deactivated users is selected (e.g., “Also show Deactivated users”). For each user, the table includes and/or displays a last name, first name, contact information (e.g., e-mail, phone), user role, status (e.g., active, deactivated, invited). In some example implementations, for each user, the user management section 2810A includes and/or displays an edit button (e.g., link, command) 2811A, which is used to initiate a user editing process to edit user information and/or user permission (e.g., access rights). Editing a user includes causing a graphical user interface (e.g., FIG. 29, graphical user interface 2900) to be loaded, displayed and/or graphically rendered.

In some example implementations, the examiner management section 2820A includes a table displaying examiners. The table displays active examiners, as well as deactivated examiners, for example, in the event that the a checkbox to view deactivated examiners is selected (e.g., “Show deactivated examiners”). For each examiner, the table includes and/or displays a last name, first name, contact information (e.g., e-mail, phone), status (e.g., active, deactivated, invited). In some example implementations, for each examiner, the examiner management section 2820A includes and/or displays an edit button (e.g., link, command) 2821A, which is used to initiate an examiner editing process to edit examiner information and/or user permission (e.g., access rights). Editing a user includes causing a graphical user interface (e.g., FIG. 29, graphical user interface 2900) to be loaded, displayed and/or graphically rendered. Editing an examiner includes causing a graphical user interface (e.g., FIG. 28B, graphical user interface 2800B) to be loaded, displayed and/or graphically rendered.

FIG. 28B illustrates a graphical user interface 2800B for editing an examiner (e.g., examiner information), in accordance with an exemplary embodiment. The graphical user interface 2800B includes examiner information, as well as textboxes, drop down menus, and/or the like for editing the examiner information. The examiner information includes a status (e.g., active, deactivated, invited, locked out, invited), first name (e.g., “Paula”), last name (e.g., “Samuels”), e-mail (e.g., “paula.samuels@email.com”), phone number, and a reports access table 2810B. The examiner information is edited, for example, by selecting a field and inputting (e.g., via a keyboard or other input means), new and/or additional information.

The reports access table 2810B includes information indicating reports which have been shared with the examiner. For example, each row in the table 2810B indicates a report which has been shared with the examiner. For each report, the table includes a report date, a name (e.g., “John Smith”) of a user who shared the report, a report type, a vendor name corresponding to the report (e.g., “Vendor name”), and/or a product name (e.g., “Online Banking”). Moreover, for each report, the table includes a button, link, and/or the like which, if selected, causes the report to be removed from the table 2810B and thus, unshared with the examiner. The graphical user interface 2800B may also include a button to submit the edited examiner information and a button to cancel the examiner editing process.

FIG. 28C illustrates a graphical user interface 2800C for adding an examiner, in accordance with an exemplary embodiment. The graphical user interface 2800C includes a message, for example, indicating that an invitation is sent when a report is shared with an examiner. The graphical user interface 2800C also includes fields to input examiner information such as an e-mail address, first name, and last name. The fields include, for example, text boxes into which text is input via a keyboard or the like. In some example implementations, if an examiner is attempted to be added via the graphical user interface 2800C, and that examiner has previously been added, a message is displayed indicating that the examiner was previously added. The graphical user interface 2800C includes buttons (e.g., command, link) to submit the added examiner information, and a cancel button to cancel the examiner adding procedure. Selecting the submit button causes the examiner to be added to (e.g., stored in), for example, a financial institution system (e.g., FIG. 25, financial institution system 2525).

FIG. 29 illustrates a graphical user interface 2900 for editing user information, in accordance with an exemplary embodiment. The graphical user interface 2900 includes user information such as first name, last name, e-mail, phone number and/or status. The user information is selected and edited, for example, by inputting text via a keyboard or the like. The graphical user interface 2900 also includes text boxes corresponding to roles which are assigned to the user. The roles include, for example, vendor/product manager, administrator, executive, and/or a user with authority to share with examiners. By selecting a text box next to a role, the user is assigned the respective role and the permissions that are associated with that role. Unchecking a checkbox causes the user to be unassigned a role. The graphical user interface 2900 includes a button or the like for submitting the edited user information and/or role. Submitting the edited user information causes the user information to be updated, modified, or the like at a financial institution system (e.g., FIG. 1, financial institution system 2525).

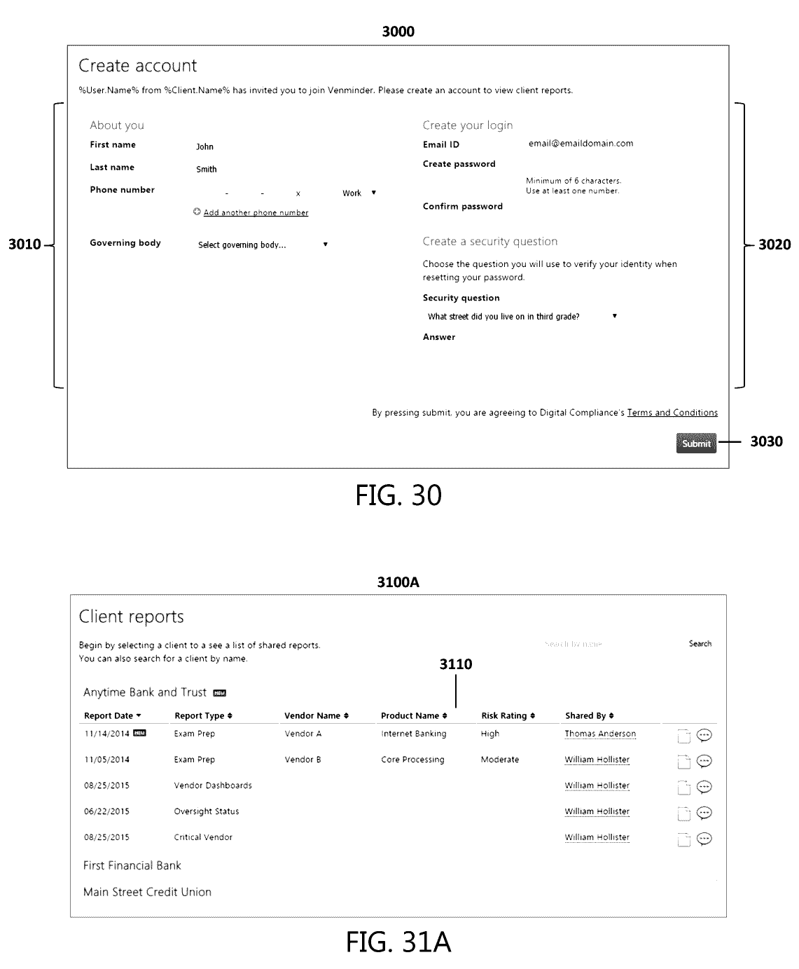

FIG. 30 illustrates a graphical user interface 3000 for enrolling examiners, in accordance with an exemplary embodiment. Enrolling examiners includes creating accounts for examiners in a financial institution system and/or in an examination report management system. The graphical user interface 3000 includes an “About you” section 3010, in which the examiner's information is input. The examiner's information includes a first name, last name, phone number and governing body. The examiner information is input for example, via a keyboard or the like at an examiner system (e.g., FIG. 25, Examiner System 2530-1). corresponding to the examiner. The governing body may be a government agency or the like administering an examination.

The graphical user interface 3000 also includes a section and/or area 3020 in which login and security question information is created. To create a login, the section 3020 includes fields in which to input an e-mail, password and password confirmation. The password and/or password confirmation field includes criteria for creating the password (e.g., minimum characters, required types of characters). To create a security question, the section 3020 includes fields (e.g., text box, drop down menu) for selecting and/or inputting a security question and corresponding answer. This information is used, for example, to retrieve login information (e.g., e-mail, password). The graphical user interface 3000 includes a submit button 3030 which, if selected (e.g., clicked, tapped), causes the information input in sections 3010 and/or 3020 to be transmitted to and/or saved by the financial institution system 2525 or examination report management system.

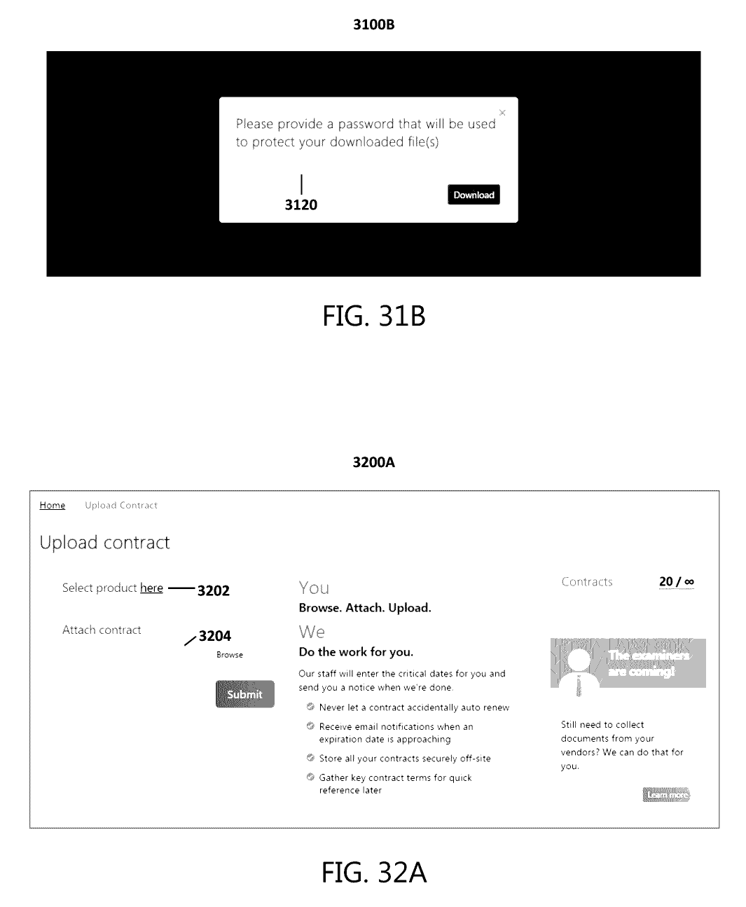

FIG. 31A illustrates a graphical user interface 3100A for viewing reports, in accordance with an exemplary embodiment. The graphical user interface 3100A is accessed by an examiner via a website and/or application, for example, using an examiner system (e.g., FIG. 25, examiner system 2530-1). The graphical user interface 3100A is used by examiners to view examination reports that have been shared by clients with that examiner. The graphical user interface includes a table 3110 which includes the examination reports that have been shared. For each examination report in the table 3110, examination report information is included and/or displayed. The examination report information may be the report date, vendor name, product name, risk rating and/or the user that shared the examination with the examiner. In some example implementations, the risk rating may be a rating such as “high,” “moderate,” and/or “low” corresponding to the vendor's product, based on the examination report. In some example implementations, multiple tables such as table 3110 are included in the graphical user interface 3100A. Each table corresponds to, for example, a different financial institution.

The graphical user interface 3100A includes a text box into which text is input to perform a search of reports that have been shared with the examiner. The search can be based on any information in a report, including the name of a user and/or of a financial institution. In some example implementations, for each report in the table 3110, icons (e.g., buttons, links) are included to send (and/or save and later send) an e-mail and/or comment regarding an examination report. The e-mail and/or comment is sent, for example, to the user and/or financial institution associated with the examination report.

FIG. 31B illustrates a graphical user interface 3100B for protecting files, according to an exemplary embodiment. That is, in FIG. 31B, a prompt to enter a password is provided (3120) prior to downloading a file from, e.g., the graphical user interface 3100A. Once a password is entered, the “Download” button may be pressed, clicked or tapped to download a selected file which is secured using the entered password in prompt 3120.

In some example implementations, settings are input and/or saved for each examiner so that each examiner is notified of examination reports that have been shared with that examiner.

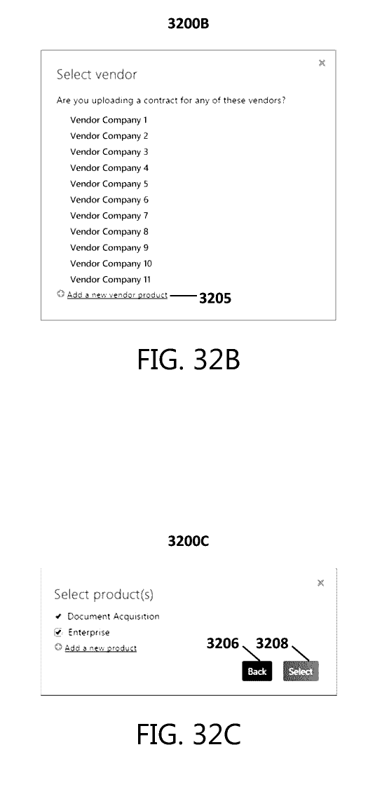

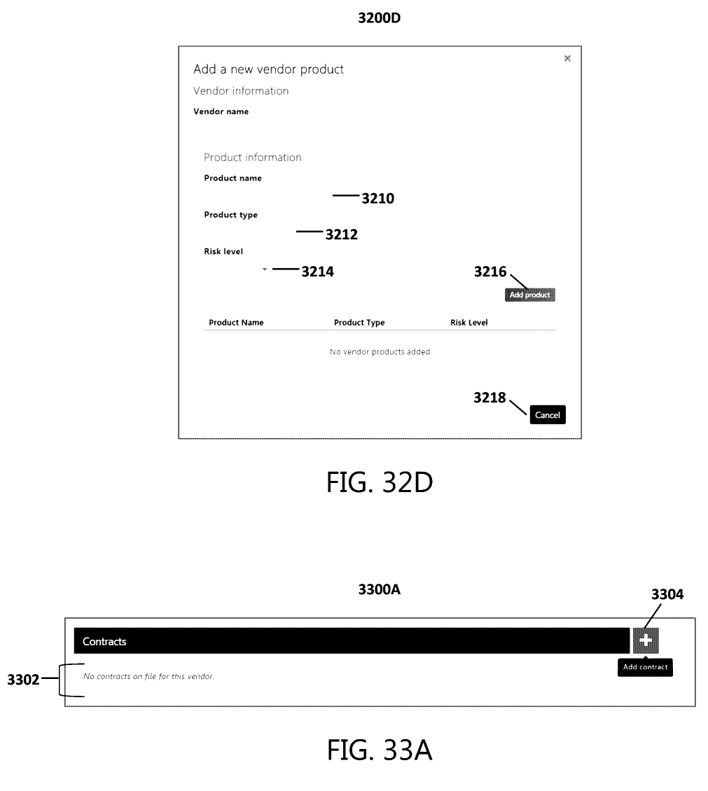

FIG. 32A illustrates a graphical user interface 3200A for uploading a contract, according to an exemplary embodiment. In some example embodiments, uploading a contract is performed via the main dashboard (e.g. FIG. 3A), using an upload contract command (e.g., FIG. 3A, 312). The interface 3200A includes a link or button 3202, that can be selected (e.g., pressed, clicked, tapped) to choose a product associated with the contract to be uploaded. The interface 3200A also includes an attach contract input or prompt 3204, through which the contract file to be uploaded is located and selected for upload. In some example embodiments, the input 3204 includes a browse button, which can be selected to initiate a browse procedure to locate the contract to upload. As shown in FIG. 32A, the interface 3200A may also include an indication of the number of contracts that have been uploaded. After a contract is uploaded and submitted, the contract is processed and verified (e.g., by a contracting module or by delivery to a contracting team).

FIG. 32B illustrates a graphical user interface 3200B for selecting a vendor associated with a contract to upload, according to an exemplary embodiment. The graphical user interface 3200B may be loaded and/or presented in response to selecting the button or link 3202 shown in FIG. 32A. More specifically, the graphical user interface 3200B may present a list of vendors and corresponding radial buttons. In some example embodiments, the list of vendors is a list of those vendors that do not have an active contract already associated therewith.

FIG. 32C illustrates a graphical user interface 3200C for selecting a product associated with the contract to be uploaded, according to an exemplary embodiment. In some example embodiments, the graphical user interface 3200C is loaded and/or displayed when a vendor is selected (e.g., from the graphical user interface 3200B), for example, in response to clicking a radial button associated with a vendor. The graphical user interface 3200C provides and/or displays a list of products associated with the selected vendor. The graphical user interface 3200C may include back and select buttons 3206 and 3208, respectively, for either browsing to a previous screen (button 3206) or selecting the product or products having their corresponding checkboxes selected. Using checkboxes for each product in the graphical user interface 3200C permits the selection of more than one product to associate with the contract to be uploaded.

In some example embodiments, a new vendor product may be added via the graphical user interface 3200B. For instance, a button, link or the like 3205 (“Add a new vendor product”) may be clicked, tapped, or selected. Selecting the button or link 3205 causes a graphical user interface for adding a new vendor product to be loaded and/or displayed (e.g., FIG. 32D).

FIG. 32D illustrates a graphical user interface 3200D for adding a new vendor product, according to an exemplary embodiment. As shown in FIG. 32D, interface 3200D includes prompts to input new product information for the product to be added, including a product name (3210), product type (3212), and risk level (3214). When a product name, product type and risk level (or a combination of required product information) has been entered, the “add product” button 3216 may be clicked and/or selected, causing the added vendor product to be displayed in the table 3218. That is, the table 3218 displays a table of new vendor products that have been added.

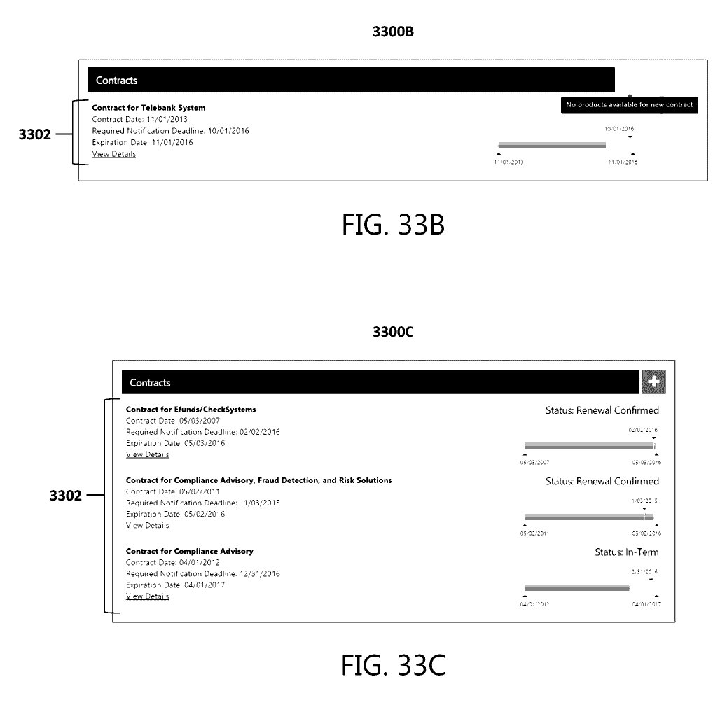

FIG. 33A illustrates a graphical user interface 3300A for viewing and uploading contracts, according to an exemplary embodiment. In some example embodiments, the graphical user interface allows a contract to be uploaded via a vendor dashboard (FIG. 4, vendor dashboard 204). For example, graphical user interface 3300A may include a listing of contracts on file for a vendor (3302) and a button, link or the like for adding a contract (3304). In FIG. 33A, the listing of contracts on file for the selected vendor is empty and thus area 3302 displays a notification indicating the same (“No contracts on file for this vendor”). To add a contract, the button 3304 may be selected (e.g., pressed, clicked, tapped), triggering a contract upload process (e.g., FIGS. 32A-32D, 34-39).

FIG. 33B illustrates a graphical user interface 3300B for viewing and uploading contracts, according to an exemplary embodiment. For instance, the listing of contracts (3302) may display a given contract, date, notification deadline, expiration date, and the like in connection with an uploaded contract. Moreover, a link to view additional details regarding that contract may be provided (e.g., “View Details”). In some example embodiments, a color coded bar or line may be provided, showing the remaining life of a contract (e.g., relative to the entire period of a contract). As in FIG. 33A, graphical user interface 3300B includes a button (3304) to add additional contracts and/or products associated with a new contract.

FIG. 33C illustrates a vendor dashboard 3300C for viewing and uploading contracts, according to an exemplary embodiment. The vendor dashboard 3300C may include a listing of contracts (3302) along with corresponding contract data (e.g., date, notification deadline, expiration date) and/or a link or the like to view additional details regarding each contract. The listed contracts may have a color coded bar or the like displayed, showing the remaining life of the contract. Additionally, a button (3304) or the like for uploading a contract may be provided on and/or by the vendor dashboard 3300C. In some example embodiments, a text-based status of each contract (e.g., “Renewal Confirmed,” “In-Term”) may be provided. It should be understood that the vendor contracts shown in vendor dashboard 3300C are associated with one particular and/or selected vendor.

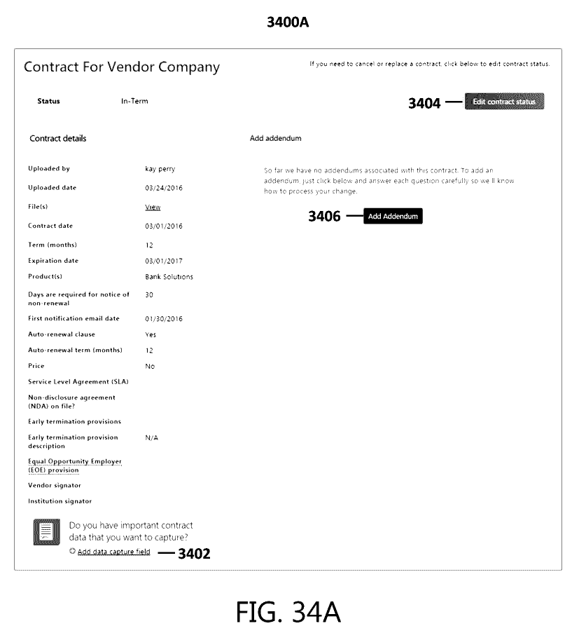

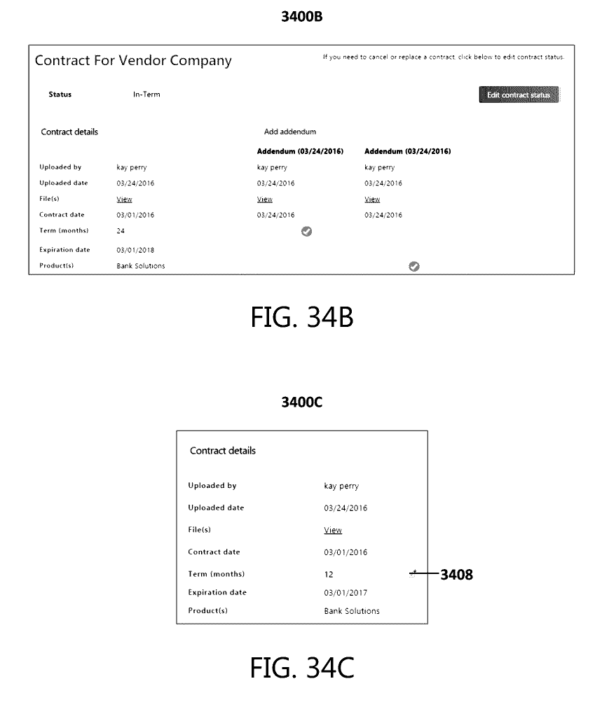

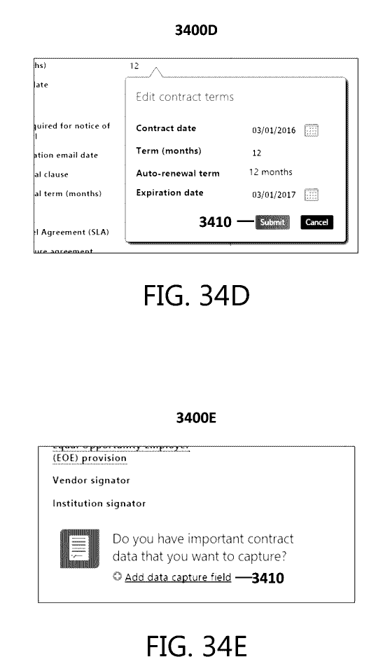

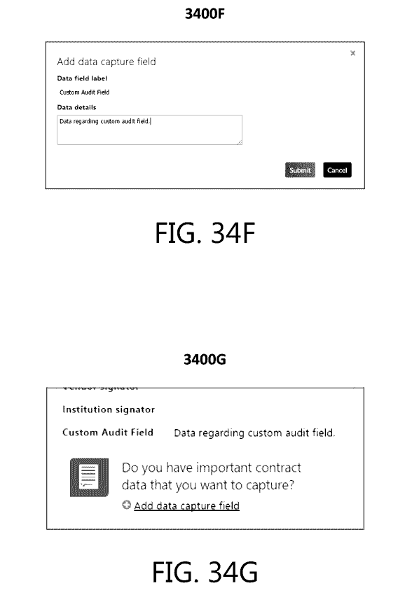

FIG. 34A illustrates a graphical user interface 3400A for viewing contract details, according to an exemplary embodiment. In some example embodiments, the graphical user interface may be loaded and/or displayed by clicking and/or selecting a “view details” button, link or the like (e.g., FIG. 33B, 33C) associated with an uploaded contract. As shown in FIG. 34A, the graphical user interface 3400A includes a contract details section, area, pane, or the like for displaying contract information such as: uploaded by (e.g., name of person who uploaded the contract), uploaded date, file(s) (e.g., and a corresponding link to view and/or load the files), contract date, term (months), expiration date, product(s), days required for notice of non-renewal, first notification e-mail date, auto renewal clause, auto-renewal term (e.g., in months), price, service level agreement (SLA), non-disclosure agreement on file indicator, early termination provisions, early termination provision description, equal opportunity employer (EOE) provision, vendor signator, institution signator. It should be understood that these types of contract information are exemplary and may be shown by default. However, a link, button or the like (e.g., “add data capture field”) 3402 may be provided to add a custom data field to the contract details. That is, such a link, button or the like 3402 allows a user to add a field that may not have been previously shown, provided or made available in connection with a contract.

The graphical user interface 3400A may also include a button or the like 3404 for editing a contract status, which is displayed adjacent to or in proximity to the button 3404. For example, the status being displayed (e.g., “In-Term”) indicates the status associated with the contract for which details are being viewed. Selecting the edit contract status button 3406 allows a user to modify the status from e.g., “in-term”, to another status.

The graphical user interface 3400A may also include a button or the like 3406 for adding (e.g., uploading, associating with) an addendum to the contract for which details are being viewed, as shown in further detail below with reference to FIG. 34B.

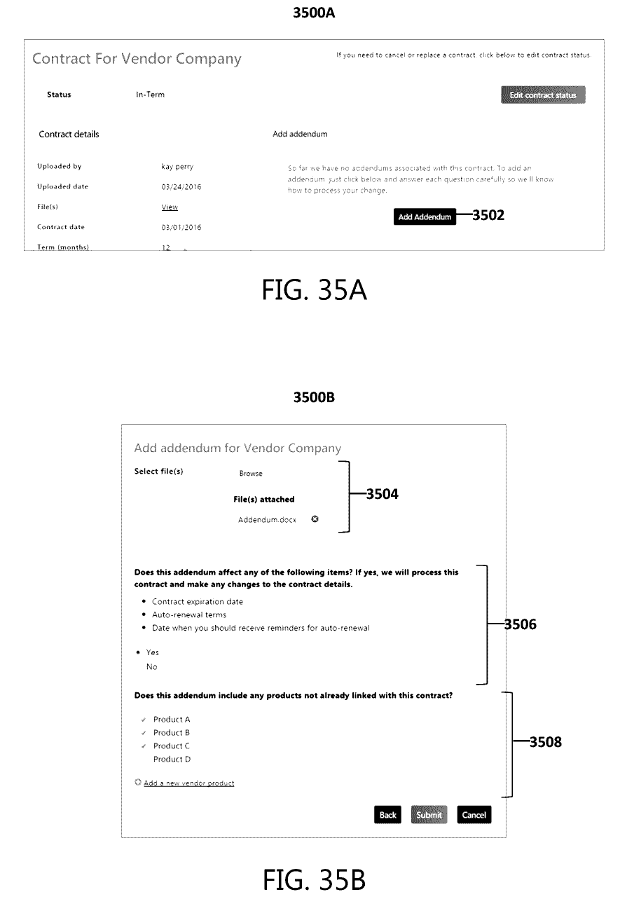

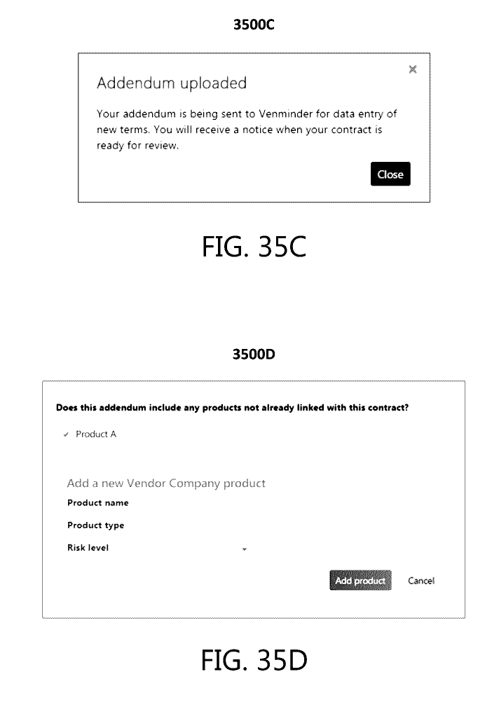

FIG. 34B illustrates a graphical user interface 3400B for adding an addendum to a contract, according to an exemplary embodiment. In some example embodiments, the graphical user interface may be loaded, displayed and/or reached by selecting the “add addendum” button in a contract details interface (e.g., FIG. 34A, button 3406). The graphical user interface may include a section, panel, or the like for displaying addendums to be added to the contract for which details are being viewed. In some example embodiments, and add addendum button causes a browse prompt or window to be loaded to locate an addendum to be retrieved, uploaded and added to the contract. In turn, information regarding the addendum may be displayed, as shown in FIG. 34B. Attaching addendums is described in further detail below with reference to FIGS. 35A-D.

FIG. 34C illustrates a graphical user interface 3400C for editing data associated with a contract, according to an exemplary embodiment. For instance, when a field in a contract details graphical user interface is hovered over, an edit icon, button or the like 3408 is displayed. Selecting the icon 3408 causes a subsequent prompt, screen or interface to be displayed and/or loaded to change the selected field of the contract for which details are being viewed.

FIG. 34D illustrates a graphical user interface 3400D for editing data associated with a contract, according to an exemplary embodiment. In some example embodiments, the graphical user interface 3400D may be reached, loaded or displayed by selecting an edit icon or the like (e.g., FIG. 34C, 3408) on a contract details interface. The graphical user interface displays data associated with the field selected to be edited, which can be modified and, in turn, saved by clicking a submit button 3410 or the like.

FIG. 34E illustrates a graphical user interface 3400E for adding a custom data field to contract details, according to an exemplary embodiment. As shown in FIG. 34E, a contract details interface may include a link or the like 3402 for adding a new data field to a contract (“add data capture field”). When the link 3402 is clicked and/or selected, a graphical user interface is displayed and/or loaded (e.g., FIG. 34F).

FIG. 34F illustrates a graphical user interface 3400F for adding a custom field and custom data to a contract and its details, according to an exemplary embodiment. For example, the graphical user interface 3400F may be displayed and/or loaded by selecting a link in a contract details page (e.g., FIG. 34E, link 3402). The graphical user interface 3400F displays prompts to enter the name of the custom data field to be created, as well as an explanation of the data expected to be received in connection with that new field. In turn, when the custom data field and details have been entered, a submit button may be clicked and/or selected to complete the process of adding the new custom data field, which is in turn displayed in a contract details page (e.g., FIG. 34G).

FIG. 34G illustrates a graphical user interface 3400G for displaying contract details, according to an exemplary embodiment. As shown in FIG. 34G, a new custom data field (e.g., “custom audit field”) and associated data details (“data regarding custom audit field”), having been newly added (e.g., via FIG. 34F), are displayed along with previously existing data associated with a contract.

FIG. 35A illustrates a graphical user interface 3500A for adding addendums, according to an exemplary embodiment. Graphical user interface 3500A may display contract details associated with a selected contract. As shown in FIG. 35A, an “add addendum” button or the like 3502 may be displayed, which, when pressed and/or selected, causes a graphical user interface or the like (e.g, FIG. 35B, 3500B) to be display and/or loaded for adding an addendum.

FIG. 35B illustrates a graphical user interface 3500B for adding addendums, according to an exemplary embodiment. In some example embodiments, the graphical user interface 3500B includes an area (e.g., panel) for selecting a file corresponding to the addendum to add to a contract (3504), an area for presenting questions regarding the addendum being added (3506) and an area for linking products with a contract (3508). More specifically, the area 3504 includes a button, link or the like which, when clicked or selected causes a browse process to begin, to browse and select the file corresponding to the addendum to be added. Once a file is browsed for and selected, its corresponding filename and/or identifier may be displayed and/or identified in a text box or the like that displays the files that are attached and are to be added as an addendum (e.g., “addendum.docx”)

The area 3506 is used to display one or more questions regarding the addendum being added. In one example embodiment, the area 3506 includes a question regarding the effect of the addendum being added on the details of the contract to which the addendum is being added (e.g., contract expiration date, auto-renewal terms, date when reminders for auto-renewal should be received). A radial button or the like can be used to select an answer (e.g., yes, no) associated with each question presented in the area 3506.

The area 3508 is used to link then-loaded products referenced in the addendum with the contract. Thus, a checkbox may be presented next to a number of then-loaded products and, if an unchecked box is checked, the product corresponding to the checked checkbox is in turn linked with the contract to which the addendum is being added. A link may also be presented in the area 3508, to add new vendor products that are not listed (e.g., not then loaded) to link with the contract. Selecting the link to add a new vendor product causes a graphical user interface 3500D to be loaded and/or displayed, as illustrated in FIG. 35D. The graphical user interface 3500D includes prompts to receive information associated with the new product being linked with the contract, including product name, product type, and risk level associated with the product. An “add product” button may be presented in the graphical user interface 3500D, to confirm the addition and/or linking of the new product with the contract, according to the details input in the graphical user interface 3500D.

The graphical user interface 3500B may include buttons or the like for navigating back, submitting the form for adding the addendum, and/or cancelling the process of adding the addendum. In some example embodiments, when the submit button is clicked and/or selected in the graphical user interface 3500B. In such cases when the submit button is selected in the interface 3500B, a graphical user interface 3500C, which is illustrated in FIG. 35C is displayed. The graphical user interface 3500C includes and/or displays a confirmation that the addendum has been uploaded and, in turn, will be processed and added to the contract.

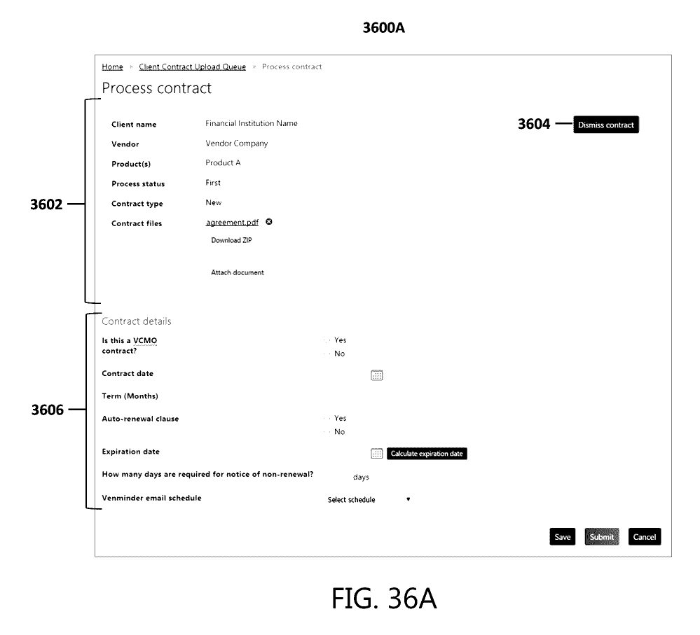

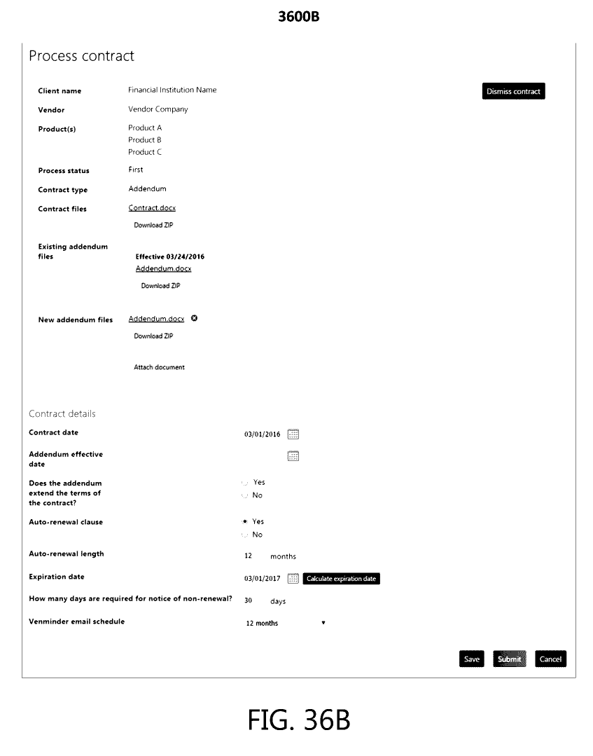

FIG. 36A illustrates a graphical user interface 3600A for processing contracts according to an exemplary embodiment. Graphical user interface 3600A, in some example embodiments, may alternatively or additionally be used to process addendums to a contract. The contract processing graphical user interface 3600A may display contract processing information (3602) and contract details to be input in connection with processing the contract (3606). The contract processing information may include a client name, vendor, product, process status, contract type and/or contract files that are or are to be associated with the contract. In some example embodiments, contract files may be downloaded individually by selecting a link associated with each file, and/or as a group, by selecting a “download ZIP” button that causes the group of files associated with the contract to be downloaded together in a compressed file. In some example embodiments, buttons or the like are presented to delete a file associated with a contract and/or to attach and associate a new file with the contract. The graphical user interface 3600A may include a button or the like (3604) the dismiss or remove a contract from processing.

The contract processing graphical user interface 3600A may also include contract details to be input in connection with the contract to be processed, in area or region 3606. The contract details to be input include corresponding prompts in the form of radial buttons, text boxes, buttons, calendars and the like. In some example embodiments, the contract details to be input in region 3606 may include an indication as to whether the contract is a specific type of contract, a contract date, a term of the contract (e.g., in term of months), an indication as to whether the contract includes an auto-renewal clause, an expiration date, the number of days required for non-renewal notice, and/or a schedule associated with the contract.

FIG. 36B illustrates a graphical user interface 3600B for processing a contract, according to an exemplary embodiment. In some example embodiments, the graphical user interface 3600B is a completed version of graphical user interface 3600A, with contract details having been input into the region 3606.

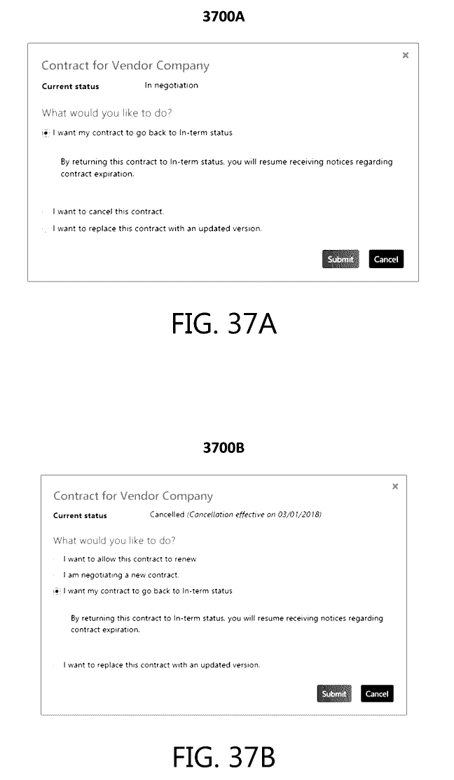

FIG. 37A illustrates a graphical user interface 3700A for modifying a contract status, according to an exemplary embodiment. As shown in FIG. 37A, graphical user interface 3700A includes contract identification as well as a corresponding status (e.g., in negotiation). The graphical user interface 3700A may include options to modify the then current status of the contract to another status (e.g., in-term, cancel, replace). When a selection has been made next to the action to be taken with respect to the contract, a submit button or the like may be selected in order to confirm and initiate the requested action. FIG. 37B illustrates a graphical user interface 3700B, in which a selection has been made to move a contract from a cancelled status to an in-term status.

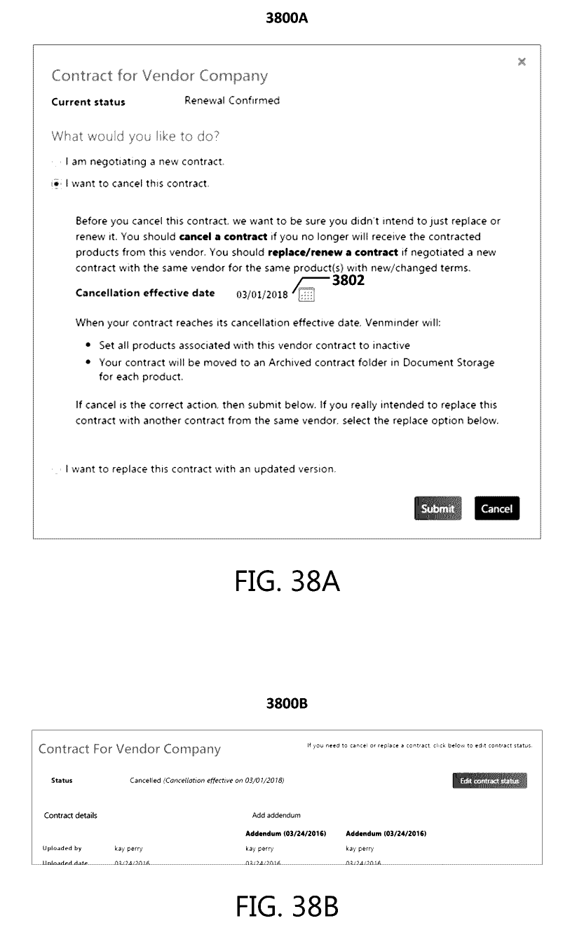

FIG. 38A illustrates a graphical user interface 3800A for cancelling a contract, according to an exemplary embodiment. As shown in FIG. 38A, the graphical user interface 3800A includes information identifying a contract and a corresponding status of that contract (e.g., “renewal confirmed”). The graphical user interface 3800A also displays options for actions to take with respect to the contract, including an action to indicate that the contract is being negotiated (e.g., “I am negotiating a new contract”), an action to indicate that the contract should be cancelled (e.g., “I want to cancel this contract”), and/or an action to indicate that the contract should be replaced with an updated version (e.g., “I want to replace the contract with an updated version”). If an action indicating that that the contract should be cancelled is selected, information regarding the cancellation process, warnings, disclaimers and the like is displayed. In such instances, an prompt 3802 may be presented to input a date on which to make the cancellation of the contract effective. The prompt 3802 may be a calendar widget or the like.

In some example embodiments, when a contract is cancelled (e.g., via the graphical user interface 3800A), the contract remains visible in an active contract interface or the like until the cancellation effective date of the contract is reached. When the cancellation effective date is reached, the contract is removed from the active contract interfaces (e.g., views) and the products associated with the contract are in turn set to an inactive status.

FIG. 38B illustrates a graphical user interface 3800B for displaying contract details, according to an exemplary embodiment. As shown in FIG. 38B, a contract status may be displayed, for example, showing that the contract is cancelled and displaying its contract cancellation effective date. In some example embodiments, the status displayed in graphical user interface 3800B is set via a contract cancellation graphical user interface (e.g., FIG. 38A, 3800A). In some example embodiments, selecting an “edit contract status” button or the like in FIG. 38B causes the graphical user interface 3800A to be displayed.

In some example embodiments, a system to assist financial institutions (e.g., FIG. 1, system 100) implements (e.g., stores, executes) a contract rules engine to set a schedule for executing contract related activities. Table 4 below illustrates an example of a contract rules engine for executing contract related activities. As shown in Table 4, the Trigger column indicates an action or set of facts that causes an action listed in the Action column to be performed (e.g., by the system 100).

TABLE 4

| Trigger | Action |
|---|---|
| Contract with auto-renewal clause reaches | Contract status changes from In-term to |
| required notification deadline | Renewal Confirmed. |
| Contract in Renewal Confirmed status | Contract status changes from Renewal |
| reaches expiration date. | Confirmed to In-term |
| Contract in In Negotiation status reaches | Contract status changes from In Negotiation |
| expiration date. | to Expired |
| Contract without auto-renewal clause | Contract status changes from In-term to |
| reaches expiration date | Expired |
| Contact in cancelled status reaches | Contract is removed from active contract lists |
| cancellation effective date | and associated products are set to inactive |
| | status. |
| Contract or addendum processed | System updates calendar with required |
| | notification deadline reminder |
| Initial upcoming contract renewal reminder | Contract drops into the Upcoming Contract |
| email distributed | Renewals grid located on the Executive |
| | Dashboard |

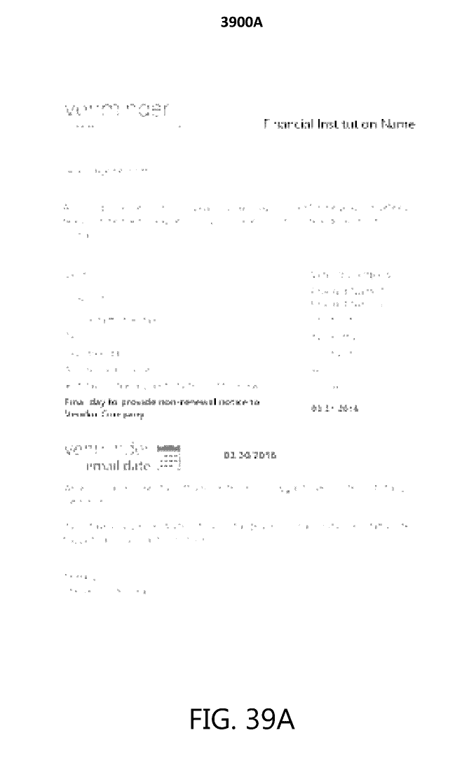

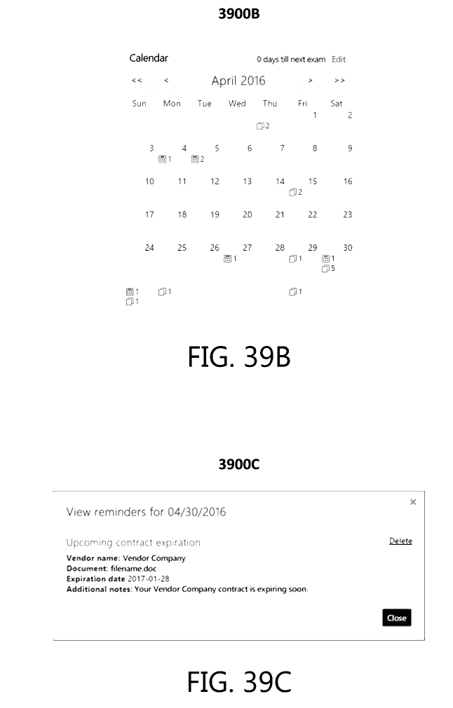

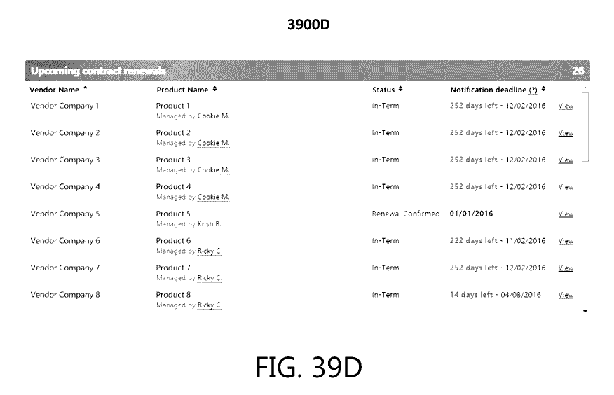

FIG. 39A illustrates a graphical user interface 3900A for displaying notifications related to a contract, according to an exemplary embodiment. As shown in FIG. 39A, the graphical user interface 3900 displays a message summarizing the purpose of the notification, as well as information identifying the vendor, product, contract effective date, term, expiration date, indication of whether a renewal clause is included in the contract related to the notification. Moreover, the notification shown in the graphical user interface 3900A displays a final day by which it is required to provide a renewal notice related to the contract.

In some example embodiments, the graphical user interface 3900A displays a calendar widget or the like which can be used to select a date on which to receive a subsequent notification. In some example embodiments, the notification is sent on a recurring schedule. Notifications may also be sent to users by other communications means including e-mail, text and the like.

FIG. 39B illustrates a calendar widget 3900B for viewing reminders, according to an exemplary embodiment. In some example embodiments, the calendar widget may be accessed via a notification, such as the notification displayed in graphical user interface 3900A. The calendar widget may also be accessed via the main dashboard, vendor dashboard, or the like. The calendar widget displays events, dates, reminders and the like associated with the contract with which the calendar is being displayed. Clicking and/or selecting a reminder or event displayed on the calendar widget 3900B causes a graphical user interface (e.g., FIG. 39C, 3900C) displaying information associated with the selected reminder.

FIG. 39C illustrates a graphical user interface 3900C for displaying reminder information, according to an exemplary embodiment. As shown in FIG. 39C, the graphical user interface indicates and/or displays a selected date from a calendar widget, for which reminders, events or the like associated with a contract are to be displayed. The graphical user interface 3900C indicates and/or displays an event such as an upcoming contract expiration (e.g., “upcoming contract expiration”) and information associated with that event, such as the vendor name, document(s), expiration date associated with the contract, and any additional notes corresponding to the event and/or reminder being displayed in the interface 3900C.

FIG. 39D illustrates a graphical user interface 3900D for displaying a list of contract renewals, according to an exemplary embodiment. As shown in FIG. 39D, a list of contracts is displayed in table form, in which each row corresponds to a contract and each column corresponds to a field associated with each contract. For example, the graphical user interface 3900D displays a vendor name, product name, status of the contract, and notification deadline (e.g., when the contract is set to expire, or when the next event associated with the contract is due). Each contract may also be associated with a link or the like to view the respective contract document.

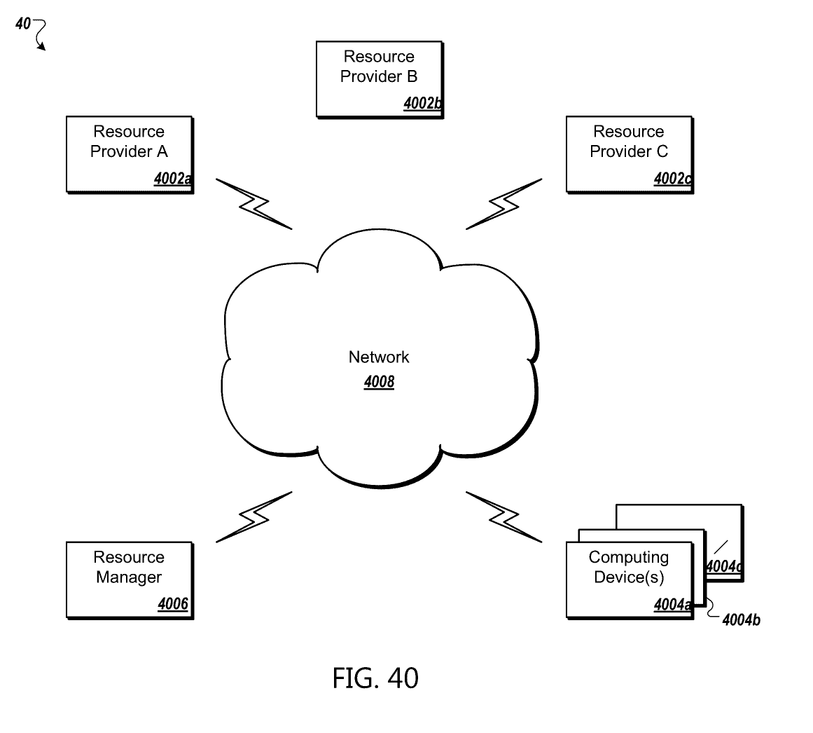

FIG. 40 shows an illustrative network environment 4000 for use in the methods and systems described herein. In brief overview, referring now to FIG. 40, a block diagram of an exemplary cloud computing environment 4000 is shown and described. The cloud computing environment 4000 may include one or more resource providers 4002a, 4002b, 4002c (collectively, 4002). Each resource provider 4002 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 4002 may be connected to any other resource provider 4002 in the cloud computing environment 4000. In some implementations, the resource providers 4002 may be connected over a computer network 4008. Each resource provider 4002 may be connected to one or more computing device 4004a, 4004b, 4004c (collectively, 4004), over the computer network 4008.

The cloud computing environment 4000 may include a resource manager 4006. The resource manager 4006 may be connected to the resource providers 4002 and the computing devices 4004 over the computer network 4008. In some implementations, the resource manager 4006 may facilitate the provision of computing resources by one or more resource providers 4002 to one or more computing devices 4004. The resource manager 4006 may receive a request for a computing resource from a particular computing device 4004. The resource manager 4006 may identify one or more resource providers 4002 capable of providing the computing resource requested by the computing device 4004. The resource manager 4006 may select a resource provider 4002 to provide the computing resource. The resource manager 4006 may facilitate a connection between the resource provider 4002 and a particular computing device 4004. In some implementations, the resource manager 4006 may establish a connection between a particular resource provider 4002 and a particular computing device 4004. In some implementations, the resource manager 4006 may redirect a particular computing device 4004 to a particular resource provider 4002 with the requested computing resource.

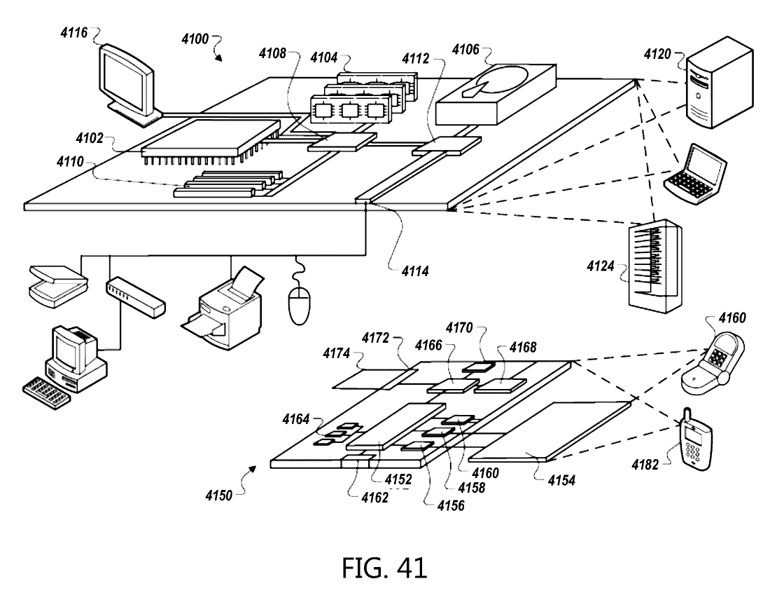

FIG. 41 shows an example of a computing device 4100 and a mobile computing device 4150 that can be used in the methods and systems described in this disclosure. The computing device 4100 is intended to represent various forms of digital computers, such as laptops, desktops, workstations, personal digital assistants, servers, blade servers, mainframes, and other appropriate computers. The mobile computing device 4150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 4100 includes a processor 4102, a memory 4104, a storage device 4106, a high-speed interface 4108 connecting to the memory 4104 and multiple high-speed expansion ports 4110, and a low-speed interface 4112 connecting to a low-speed expansion port 4114 and the storage device 4106. Each of the processor 4102, the memory 4104, the storage device 4106, the high-speed interface 4108, the high-speed expansion ports 4110, and the low-speed interface 4112, are interconnected using various busses, and may be mounted on a common motherboard or in other manners as appropriate. The processor 4102 can process instructions for execution within the computing device 4100, including instructions stored in the memory 4104 or on the storage device 4106 to display graphical information for a GUI on an external input/output device, such as a display 4116 coupled to the high-speed interface 4108. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 4104 stores information within the computing device 4100. In some implementations, the memory 4104 is a volatile memory unit or units. In some implementations, the memory 4104 is a non-volatile memory unit or units. The memory 4104 may also be another form of computer-readable medium, such as a magnetic or optical disk.

The storage device 4106 is capable of providing mass storage for the computing device 4100. In some implementations, the storage device 4106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 4102), perform one or more methods, such as those described above. The instructions can also be stored by one or more storage devices such as computer- or machine-readable mediums (for example, the memory 4104, the storage device 4106, or memory on the processor 4102).

The high-speed interface 4108 manages bandwidth-intensive operations for the computing device 4100, while the low-speed interface 4112 manages lower bandwidth-intensive operations. Such allocation of functions is an example only. In some implementations, the high-speed interface 4108 is coupled to the memory 4104, the display 4116 (e.g., through a graphics processor or accelerator), and to the high-speed expansion ports 4110, which may accept various expansion cards (not shown). In the implementation, the low-speed interface 4112 is coupled to the storage device 4106 and the low-speed expansion port 4114. The low-speed expansion port 4114, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 4100 may be implemented in a number of different forms, as shown in the figure. For example, it may be implemented as a standard server 4120, or multiple times in a group of such servers. In addition, it may be implemented in a personal computer such as a laptop computer 4122. It may also be implemented as part of a rack server system 4124. Alternatively, components from the computing device 4100 may be combined with other components in a mobile device (not shown), such as a mobile computing device 4150. Each of such devices may contain one or more of the computing device 4100 and the mobile computing device 4150, and an entire system may be made up of multiple computing devices communicating with each other.

The mobile computing device 4150 includes a processor 4152, a memory 4164, an input/output device such as a display 4154, a communication interface 4166, and a transceiver 4168, among other components. The mobile computing device 4150 may also be provided with a storage device, such as a micro-drive or other device, to provide additional storage. Each of the processor 4152, the memory 4164, the display 4154, the communication interface 4166, and the transceiver 4168, are interconnected using various buses, and several of the components may be mounted on a common motherboard or in other manners as appropriate.

The processor 4152 can execute instructions within the mobile computing device 4150, including instructions stored in the memory 4164. The processor 4152 may be implemented as a chipset of chips that include separate and multiple analog and digital processors. The processor 4152 may provide, for example, for coordination of the other components of the mobile computing device 4150, such as control of user interfaces, applications run by the mobile computing device 4150, and wireless communication by the mobile computing device 4150.

The processor 4152 may communicate with a user through a control interface 4158 and a display interface 4156 coupled to the display 4154. The display 4154 may be, for example, a TFT (Thin-Film-Transistor Liquid Crystal Display) display or an OLED (Organic Light Emitting Diode) display, or other appropriate display technology. The display interface 4156 may comprise appropriate circuitry for driving the display 4154 to present graphical and other information to a user. The control interface 4158 may receive commands from a user and convert them for submission to the processor 4152. In addition, an external interface 4162 may provide communication with the processor 4152, so as to enable near area communication of the mobile computing device 4150 with other devices. The external interface 4162 may provide, for example, for wired communication in some implementations, or for wireless communication in other implementations, and multiple interfaces may also be used.

The memory 4164 stores information within the mobile computing device 4150. The memory 4164 can be implemented as one or more of a computer-readable medium or media, a volatile memory unit or units, or a non-volatile memory unit or units. An expansion memory 4174 may also be provided and connected to the mobile computing device 4150 through an expansion interface 4172, which may include, for example, a SIMM (Single In Line Memory Module) card interface. The expansion memory 4174 may provide extra storage space for the mobile computing device 4150, or may also store applications or other information for the mobile computing device 4150. Specifically, the expansion memory 4174 may include instructions to carry out or supplement the processes described above, and may include secure information also. Thus, for example, the expansion memory 4174 may be provided as a security module for the mobile computing device 4150, and may be programmed with instructions that permit secure use of the mobile computing device 4150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 4152), perform one or more methods, such as those described above. The instructions can also be stored by one or more storage devices, such as one or more computer- or machine-readable mediums (for example, the memory 4164, the expansion memory 4174, or memory on the processor 4152). In some implementations, the instructions can be received in a propagated signal, for example, over the transceiver 4168 or the external interface 4162.

The mobile computing device 4150 may communicate wirelessly through the communication interface 4166, which may include digital signal processing circuitry where necessary. The communication interface 4166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 4168 using a radio-frequency. In addition, short-range communication may occur, such as using a Bluetooth®, Wi-Fi™, or other such transceiver (not shown). In addition, a GPS (Global Positioning System) receiver module 4170 may provide additional navigation- and location-related wireless data to the mobile computing device 4150, which may be used as appropriate by applications running on the mobile computing device 4150.

The mobile computing device 4150 may also communicate audibly using an audio codec 4160, which may receive spoken information from a user and convert it to usable digital information. The audio codec 4160 may likewise generate audible sound for a user, such as through a speaker, e.g., in a handset of the mobile computing device 4150. Such sound may include sound from voice telephone calls, may include recorded sound (e.g., voice messages, music files, etc.) and may also include sound generated by applications operating on the mobile computing device 4150.

The mobile computing device 4150 may be implemented in a number of different forms, as shown in the figure. For example, it may be implemented as a cellular telephone 4180. It may also be implemented as part of a smart-phone 4182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

1.-24. (canceled)

25. A system for managing examination reports and contracts between and among members of a network comprising financial institutions, financial institution vendors, and examiners, the system comprising:
a memory, and
a processor communicatively coupled to the memory, the processor being operable to:
provide a network including user computing devices corresponding to users and to examiner systems corresponding to examiners, wherein each of the users is one or more of a general user, administrator, vendor manager, product manager, expert, and executive;
store, in the memory, at least one of a plurality of user records corresponding to the users on the network, a plurality of examiner records corresponding to the examiners on the network, and a plurality of examination report records;
receive, from a user computing device corresponding to a user, over the network, a request to share an examination report record from the plurality of examination report records, the request including at least one of an examination report date, vendor, product and examiner information; and
update access settings associated with the examination report record identified in the request, the access setting being updated to indicate that the examination report record is accessible by an examiner corresponding to the examiner information included in the request.

26. The system of claim 25, wherein the processor is operable to:
cause to display a first graphical user interface including a list of examination report records selected from the plurality of examination records stored in the memory,
wherein for each examination report record, the first graphical user interface includes one or more of a report date, vendor name, product name, risk rating and user name associated with the examination report record.

27. The system of claim 26,
wherein for each examination report record, the first graphical user interface includes one or more of a comment option and an e-mail option to transmit information to users associated with examination report records.

28. The system of claim 26, wherein the first graphical user interface includes an indication (e.g., badge, icon) identifying examination report records newly added to the list of examination report records.

29. The system of claim 26, wherein the first graphical user interface is caused to be displayed at an examiner system corresponding to an examiner associated with the list of examination report records.

30. The system of claim 26, wherein each of the examination report records stored in the memory include corresponding access settings, the access setting including one or more examiners with which to share the respective examination report record.

31. The system of claim 26, wherein the processor is further operable to:
receive, via an input in the first graphical user interface, an access request to access an examination report record from the list of examination report records; and
cause to display, in response to the access request, at least a portion of the examination report record identified in the access request.

32. The system of claim 27,
wherein the access request is received from an examiner system over the network, the examiner system corresponding to an examiner associated with the examination report record, and
wherein the portion of the examination report record is caused to be displayed at the examiner system.

33. The system of claim 25, wherein the processor is operable to:
cause to display a second graphical user interface including a list of users and a list of examiners, the graphical user interface including one or more of a button to add a user, a button to add an examiner, a link to edit a user for each of the plurality of users, and a link to edit an examiner for each of the plurality of examiners, wherein
selection of the button to add a user causes a third graphical user interface to be displayed,
selection of the button to add an examiner causes a fourth graphical user interface to be displayed,
selection of a link to edit a user causes a fifth graphical user interface to be displayed, and
selection of a link to edit an examiner causes a sixth graphical user interface to be displayed.

34. The system of claim 33,
wherein the third graphical user interface includes user information corresponding to the user of the plurality of users,
wherein the processor is operable to:
receive updated user information; and
update the user record corresponding to the user, based on the received updated user information.

35. The system of claim 33,
wherein the fourth graphical user interface includes examiner information corresponding to the examiner of the plurality of examiners,
wherein the processor is further operable to:
receive updated examiner information; and
update the examiner record corresponding to the examiner, based on the received updated examiner information.

36. The system of claim 25, wherein at least a portion of the plurality of examination report records are received, over the network, from entities administering examinations identified in the examination report records.

37. A method for managing examination reports, comprising:
providing a network including user computing devices corresponding to users and to examiner systems corresponding to examiners, wherein each of the users is one or more of a general user, administrator, vendor manager, product manager, expert, and executive;
storing, in a memory, at least one of a plurality of user records corresponding to the users on the network, a plurality of examiner records corresponding to the examiners on the network, and a plurality of examination report records;
receiving, from a user computing device corresponding to a user, over the network, a request to share an examination report record from the plurality of examination report records, the request including at least one of an examination report date, vendor, product and examiner information; and
updating access settings associated with the examination report record identified in the request, the access setting being updated to indicate that the examination report record is accessible by an examiner corresponding to the examiner information included in the request.

38. The method of claim 37, further comprising:
causing to display a first graphical user interface including a list of examination report records selected from the plurality of examination records stored in the memory,
wherein for each examination report record, the first graphical user interface includes one or more of a report date, vendor name, product name, risk rating and user name associated with the examination report record.

39. The method of claim 38,
wherein for each examination report record, the first graphical user interface includes one or more of a comment option and an e-mail option to transmit information to users associated with examination report records.

40. The method of claim 38, wherein the first graphical user interface includes an indication (e.g., badge, icon) identifying examination report records newly added to the list of examination report records.

41. The method of claim 38, wherein the first graphical user interface is caused to be displayed at an examiner system corresponding to an examiner associated with the list of examination report records.

42. The method of claim 38, wherein each of the examination report records stored in the memory include corresponding access settings, the access setting including one or more examiners with which to share the respective examination report record.

43. The method of claim 38, further comprising:
receiving, via an input in the first graphical user interface, an access request to access an examination report record from the list of examination report records; and
causing to display, in response to the access request, at least a portion of the examination report record identified in the access request.

44. The method of claim 39,
wherein the access request is received from an examiner system over the network, the examiner system corresponding to an examiner associated with the examination report record, and
wherein the portion of the examination report record is caused to be displayed at the examiner system.

45. The method of claim 37, further comprising:
causing to display a second graphical user interface including a list of users and a list of examiners, the graphical user interface including one or more of a button to add a user, a button to add an examiner, a link to edit a user for each of the plurality of users, and a link to edit an examiner for each of the plurality of examiners, wherein
selection of the button to add a user causes a third graphical user interface to be displayed,
selection of the button to add an examiner causes a fourth graphical user interface to be displayed,
selection of a link to edit a user causes a fifth graphical user interface to be displayed, and
selection of a link to edit an examiner causes a sixth graphical user interface to be displayed.

46. The method of claim 45,
wherein the third graphical user interface includes user information corresponding to the user of the plurality of users,
wherein the method further comprises:
receiving updated user information; and
updating the user record corresponding to the user, based on the received updated user information.

47. The method of claim 45,
wherein the fourth graphical user interface includes examiner information corresponding to the examiner of the plurality of examiners,
wherein method further comprises:
receiving updated examiner information; and
updating the examiner record corresponding to the examiner, based on the received updated examiner information.

48. The method of claim 37, wherein at least a portion of the plurality of examination report records are received, over the network, from entities administering examinations identified in the examination report records.
